(19) United States
(12) Patent Application Publication
(10) Pub. No.: US 2015/0178850 A1
(43) Pub. Date: Jun. 25, 2015

(54) INSURANCE APPLICATIONS UTILIZING VIRTUAL ENGINEERING DATA

(71) Applicant: The Travelers Indemnity Company, Hartford, CT (US)

(72) Inventors: John P. Machnicki, Somers, CT (US); Robert J. Kreuzer, Terryville, CT (US); Keith D. Andersen, Canton, CT (US)

(73) Assignee: The Travelers Indemnity Company, Hartford, CT (US)

(21) Appl. No.: 14/139,876

(22) Filed: Dec. 24, 2013

(51) Int. Cl. G06Q 40/08

(52) U.S. Cl. CPC G06Q 40/08

(57) ABSTRACT

Systems, apparatus, interfaces, methods, and articles of manufacture that provide for insurance claims handling, underwriting, and risk assessment applications utilizing virtual engineering data.

### BACKGROUND

Insurance claims determinations often involve analysis by an engineer to ensure that only those losses that were likely caused by an insured's activities are compensated. Due to the large number of claims that most insurance carriers handle, as well as the vast geographic distribution of claim events, insurance companies often require the services of consulting or contract engineers to facilitate such determinations. Utilization of such third-party engineering services, however, often causes delays in claim determination responsiveness (e.g., increases claim handling cycle time), increases the expense of claim handling, and often leads to disparate conclusions due to varying methodologies of managing such third-party engineers and related services.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a flow diagram of a prior art method;

FIG. 3 is a block diagram of a system according to some embodiments;

FIG. 4 is a diagram of an example data storage structure according to some embodiments;

FIG. 5 is a flow diagram of a method according to some embodiments;

FIG. 6 is a flow diagram of a method according to some embodiments;

FIG. 7 is a flow diagram of a method according to some embodiments;

FIG. 8 is a flow diagram of a method according to some embodiments;

FIG. 9 is a diagram of an exemplary risk matrix according to some embodiments;

FIG. 10 is a flow diagram of a method according to some embodiments;

FIG. 11A, FIG. 11B, and FIG. 11C are diagrams of example interfaces according to some embodiments;

FIG. 12 is a block diagram of an apparatus according to some embodiments; and

FIG. 13A, FIG. 13B, FIG. 13C, and FIG. 13D are perspective diagrams of exemplary data storage devices according to some embodiments.

### DETAILED DESCRIPTION

Embodiments described herein are descriptive of systems, apparatus, methods, interfaces, and articles of manufacture for insurance, underwriting, and/or risk assessment applications utilizing virtual engineering data. In some embodiments, for example, virtual engineering data may be utilized to perform claim handling processes (e.g., without the need to hire or retain a third-party engineer for resolution of every claim) and/or to underwrite, assess, quote, and/or sell one or more underwriting products (such as an insurance policy).

As utilized herein, the terms “virtual engineering data” or “Virtual Engineering Data (VED)” may generally refer to data received, acquired, compiled, aggregated, and/or stored based on a plurality of engineering reports and/or assessments conducted with respect to a plurality of insurance claims and/or policies. Third-party and/or internal engineer determinations, recommendations, and/or analysis results may, for example, be stored in a database in association with related data (such as claim and/or policy data utilized to achieve and/or arrive at the particular determination, recommendation, and/or analysis result). In some embodiments, virtual engineering data may relate to and/or define or describe relationships between various engineering parameters (and/or values thereof) and engineering determinations, recommendations, and/or analysis results. In the case of an engineering analysis of potential vibratory damage (e.g., due to construction activities), which will be utilized as a continuing and non-limiting example herein, stored virtual engineering data may indicate that the likelihood of damage from a certain type of vibratory energy source (e.g., a jackhammer) outside of a certain radius is low (relatively, absolutely, quantitatively, and/or qualitatively).

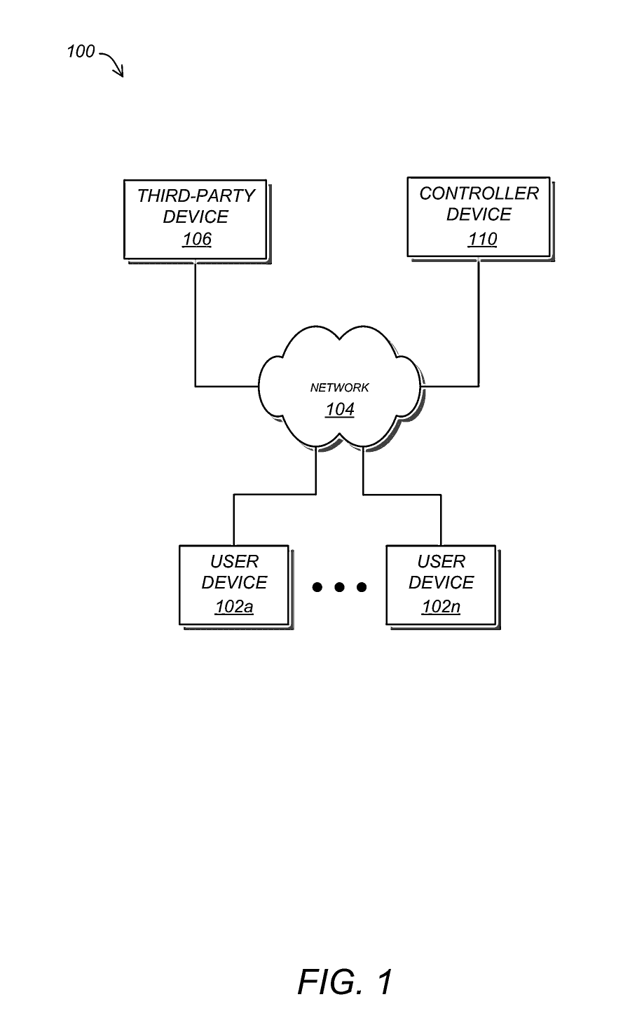

Referring first to FIG. 1, a block diagram of a system 100 according to some embodiments is shown. In some embodiments, the system 100 may comprise a plurality of user devices 102a-n, a network 104, a third-party device 106, and/or a controller device 110. As depicted in FIG. 1, any or all of the devices 102a-n, 106, 110 (or any combinations thereof) may be in communication via the network 104. In some embodiments, the system 100 may be utilized to provide (and/or receive) engineering data, virtual engineering data, claim handling data, and/or other data or metrics. The controller device 110 may, for example, interface with one or more of the user devices 102a-n and/or the third-party device 106 to acquire, gather, aggregate, process, and/or utilize virtual engineering data and/or other data or metrics in accordance with embodiments described herein.

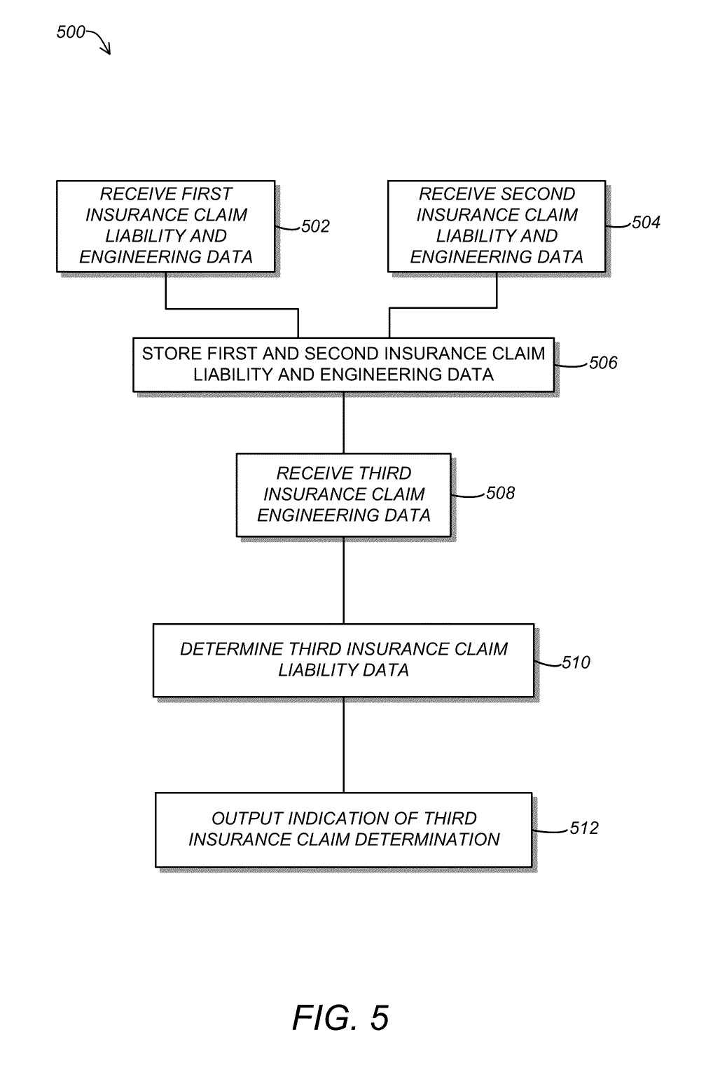

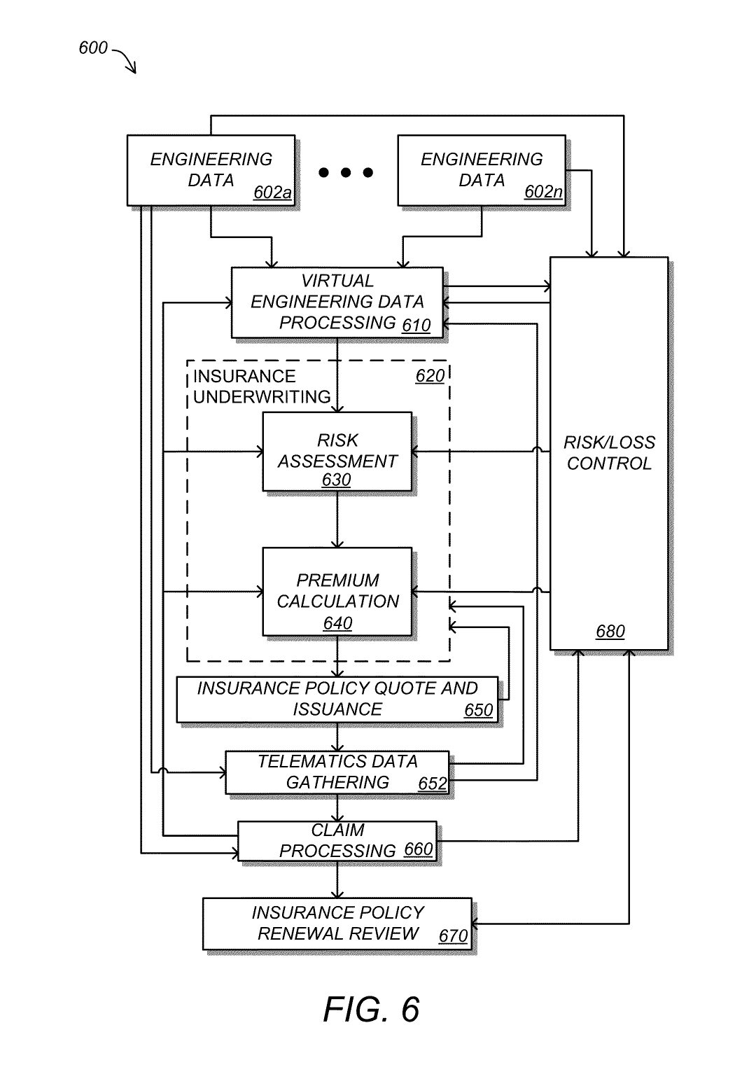

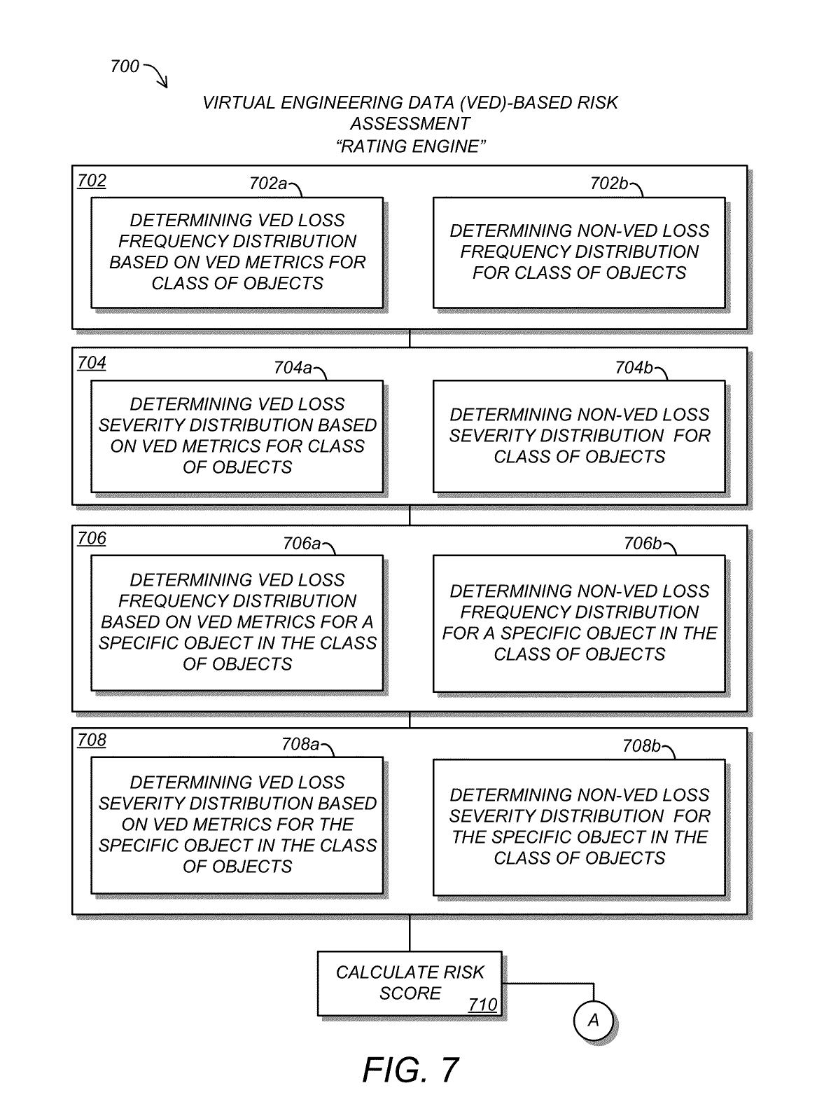

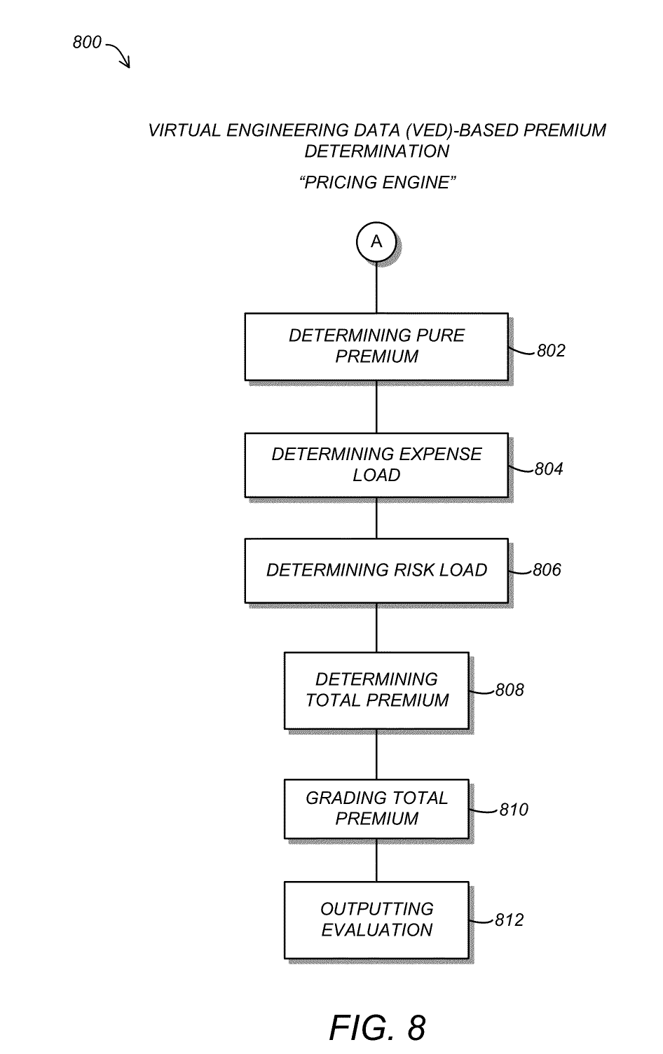

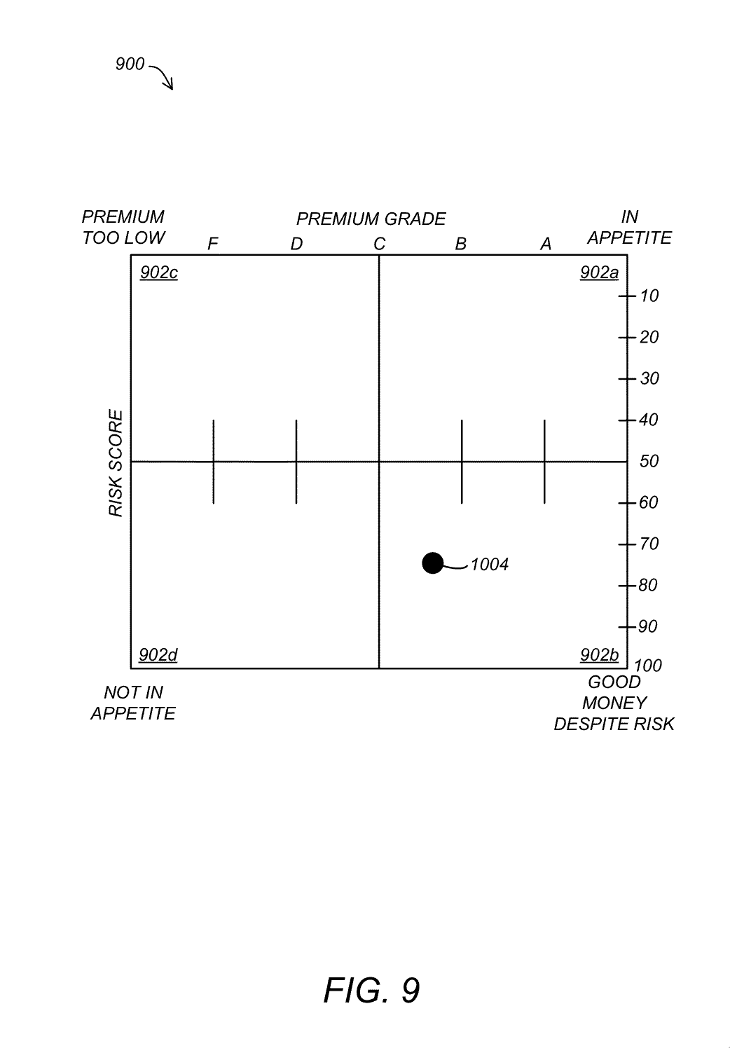

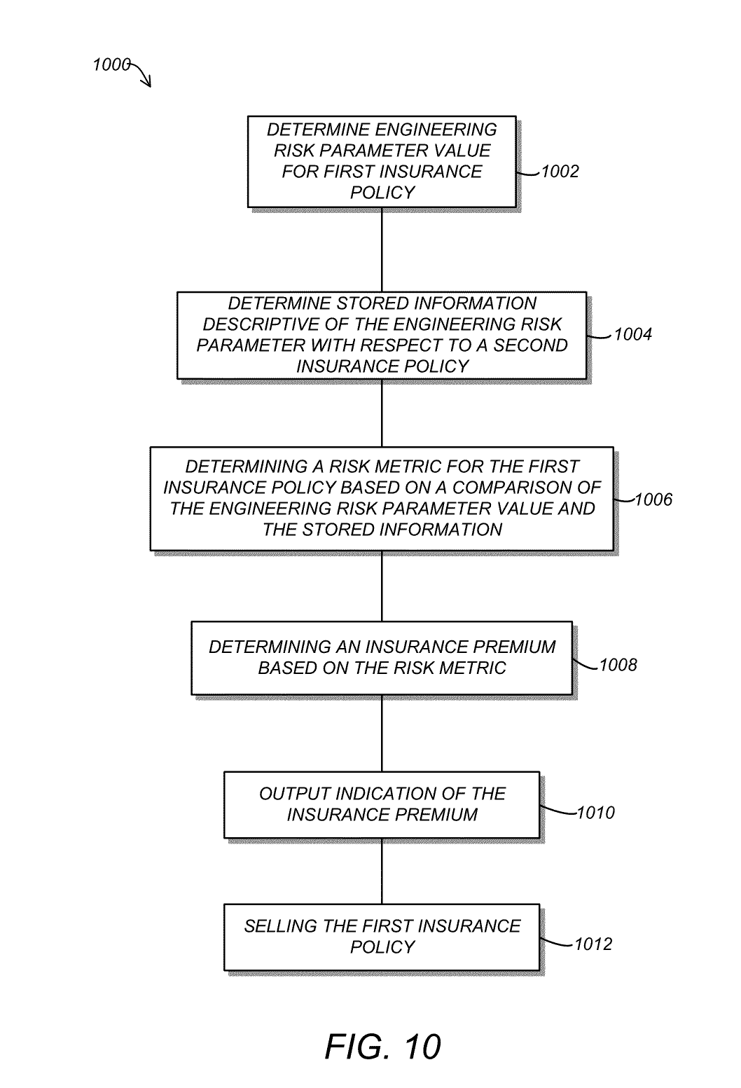

Fewer or more components 102a-n, 104, 106, 110 and/or various configurations of the depicted components 102a-n, 104, 106, 110 may be included in the system 100 without deviating from the scope of embodiments described herein. In some embodiments, the components 102a-n, 104, 106, 110 may be similar in configuration and/or functionality to similarly named and/or numbered components as described herein. In some embodiments, the system 100 (and/or portion thereof) may comprise a risk assessment and/or underwriting program and/or platform programmed and/or otherwise configured to execute, conduct, and/or facilitate any of the various methods 500, 600, 700, 800, 1000 of FIG. 5, FIG. 6, FIG. 7, FIG. 8, and/or FIG. 10 and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., claim adjuster and/or handler and/or underwriter workstations), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as claim handlers/adjusters, underwriters, account managers, agents/brokers, customer service representatives, data acquisition partners and/or consultants or service providers, and/or underwriting product customers. According to some embodiments, the user devices 102a-n may communicate with the controller device 110 via the network 104, such as to conduct claims and/or underwriting inquiries and/or processes utilizing virtual engineering data as described herein.

In some embodiments, the user devices 102a-n may interface with the controller device 110 to effectuate communications (direct or indirect) with one or more other user devices 102a-n (such communication not explicitly shown in FIG. 1), such as may be operated by other users. In some embodiments, the user devices 102a-n may interface with the controller device 110 to effectuate communications (direct or indirect) with the third-party device 106 (such communication also not explicitly shown in FIG. 1). In some embodiments, the user devices 102a-n and/or the third-party device 106 may comprise one or more sensors configured and/or coupled to sense, measure, calculate, and/or otherwise process or determine virtual engineering data. In some embodiments, such sensor data may be provided to the controller device 110, such as for utilization of the virtual engineering data in claims adjusting/handling, pricing, risk assessment, line and/or limit setting, quoting, and/or selling or re-selling an underwriting product.

The network 104 may, according to some embodiments, comprise a Local Area Network (LAN; wireless and/or wired), cellular telephone, Bluetooth®, and/or Radio Frequency (RF) network with communication links between the controller device 110, the user devices 102a-n, and/or the third-party device 106. In some embodiments, the network 104 may comprise direct communications links between any or all of the components 102a-n, 106, 110 of the system 100. The user devices 102a-n may, for example, be directly interfaced or connected to one or more of the controller device 110 and/or the third-party device 106 via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110 of the system 100. The network 104 may comprise one or more cellular telephone networks with communication links between the user devices 102a-n and the controller device 110, for example, and/or may comprise the Internet, with communication links between the controller device 110 and the third-party device 106, for example.

The third-party device 106, in some embodiments, may comprise any type or configuration a computerized processing device such as a PC, laptop computer, computer server, database system, and/or other electronic device, devices, or any combination thereof. In some embodiments, the third-party device 106 may be owned and/or operated by a third-party (i.e., an entity different than any entity owning and/or operating either the user devices 102a-n or the controller device 110). The third-party device 106 may, for example, be owned and/or operated by a service provider such as an engineering contractor and/or consultant and/or a data and/or data service provider such as a municipality, mapping service, construction monitoring entity, surveying entity, etc. In some embodiments, the third-party device 106 may supply and/or provide data such as virtual engineering data and/or other data to the controller device 110 and/or the user devices 102a-n. In some embodiments, the third-party device 106 may comprise a plurality of devices and/or may be associated with a plurality of third-party entities.

In some embodiments, the controller device 110 may comprise an electronic and/or computerized controller device such as a computer server communicatively coupled to interface with the user devices 102a-n and/or the third-party device 106 (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n and/or the third-party device 106. The controller device 110 may also or alternatively comprise a plurality of electronic processing devices located at one or more various sites and/or locations.

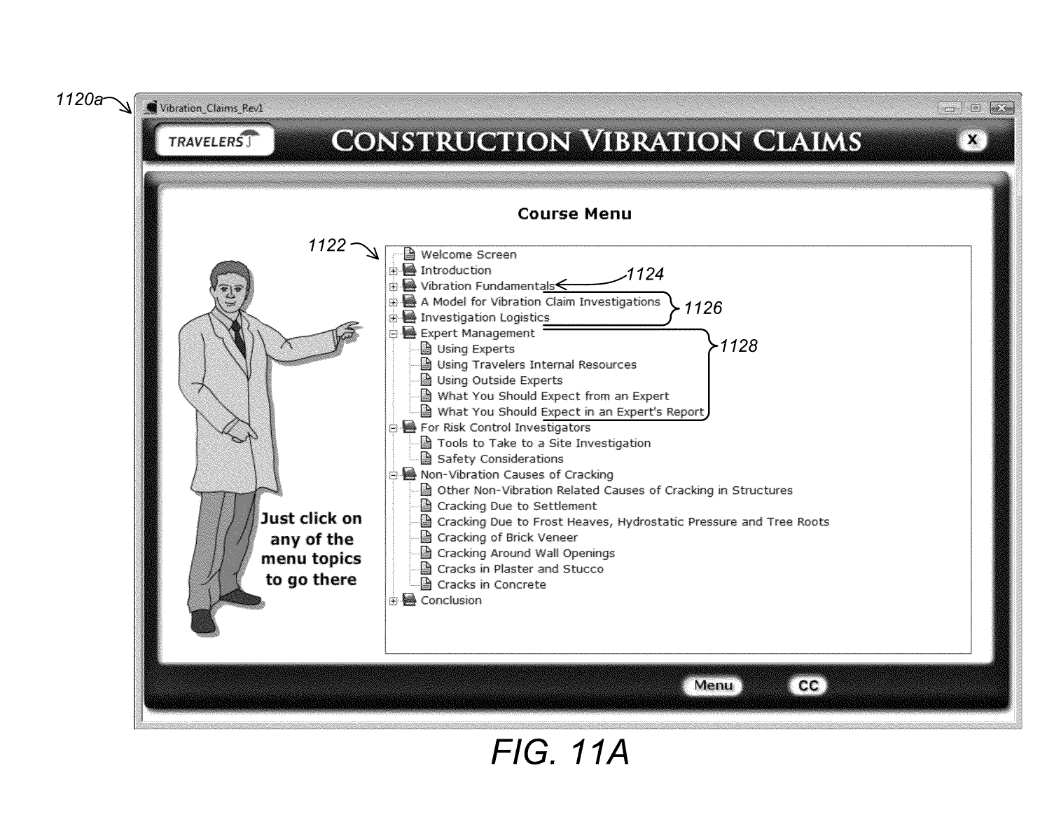

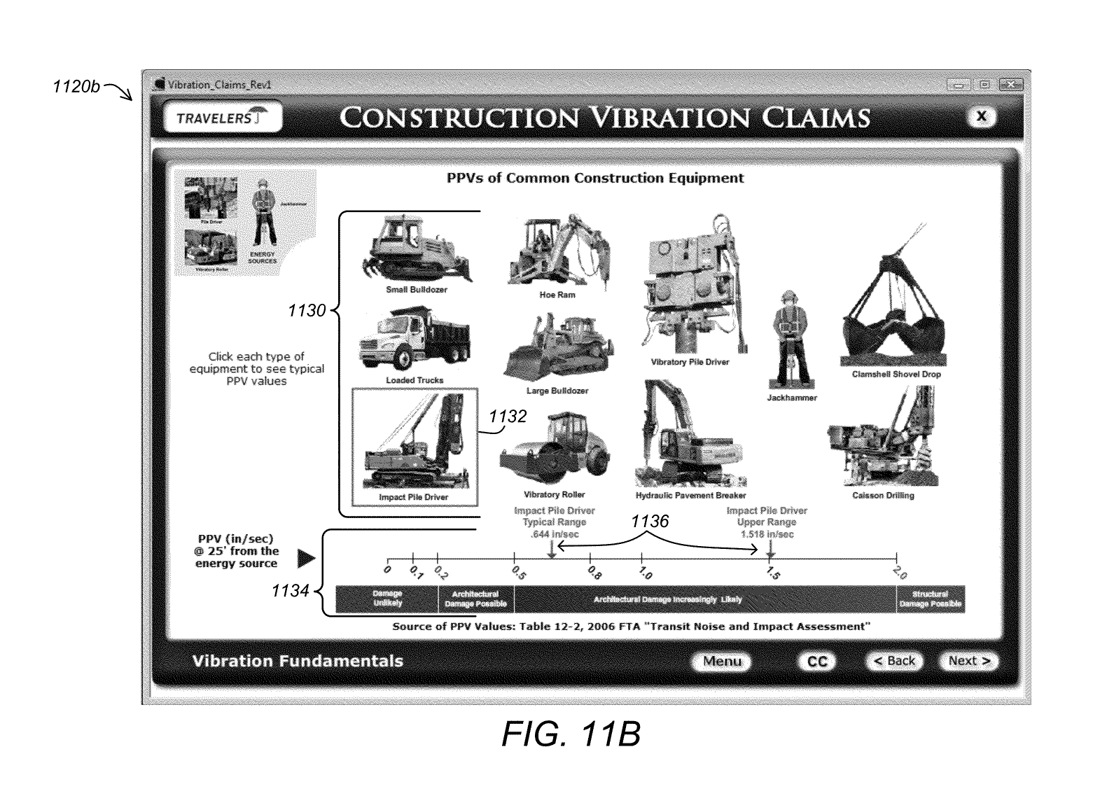

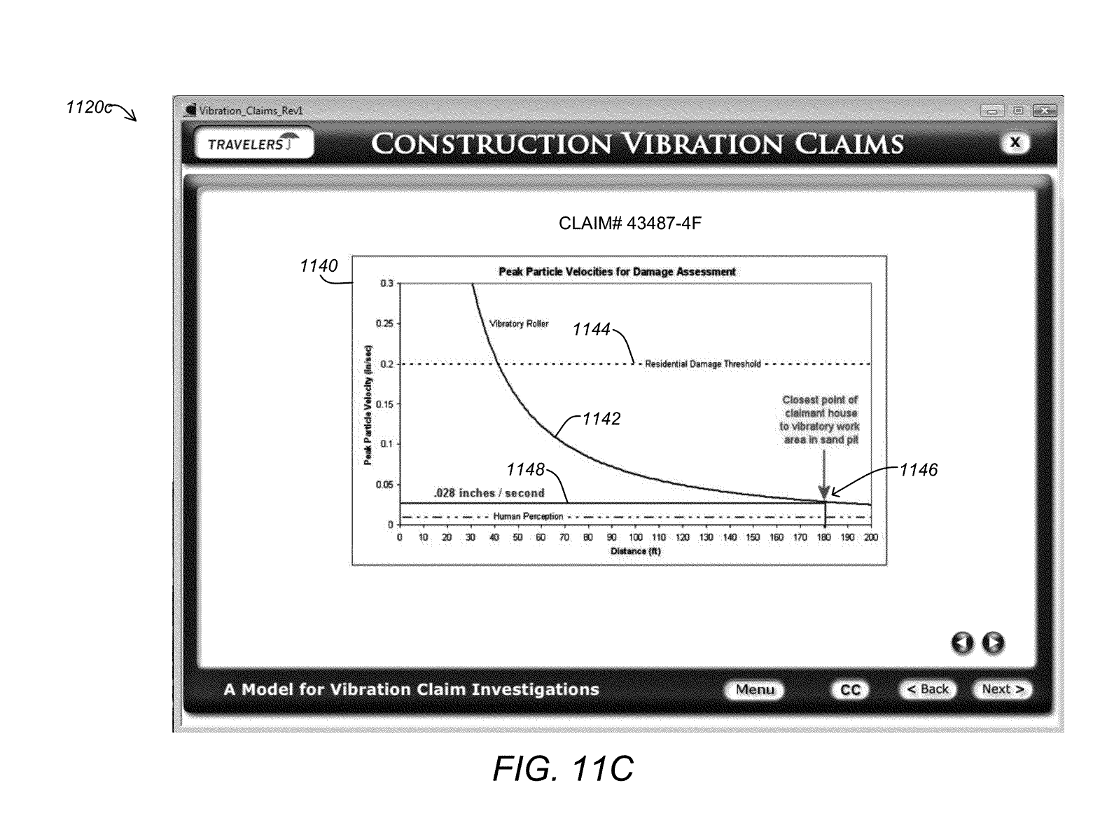

According to some embodiments, the controller device 110 may store and/or execute specially programmed instructions to operate in accordance with embodiments described herein. The controller device 110 may, for example, execute one or more programs that facilitate the utilization of virtual engineering data in the claims processing, pricing, underwriting, and/or issuance of one or more insurance and/or underwriting products. According to some embodiments, the controller device 110 may comprise a computerized processing device such as a PC, laptop computer, computer server, and/or other electronic device to manage and/or facilitate transactions and/or communications regarding the user devices 102a-n. A claims adjuster/handler and/or an underwriter (and/or customer, client, or company) may, for example, utilize the controller device 110 to (i) manage and/or process one or more insurance claims, (ii) price and/or underwrite one or more products such as insurance, indemnity, and/or surety products, (iii) determine and/or be provided with virtual engineering data and/or other information, and/or (iv) provide an interface via which an underwriting entity may manage and/or facilitate underwriting of various products (e.g., in accordance with embodiments described herein; such as the example interfaces 1120a-c of FIG. 11A, FIG. 11B, and/or FIG. 11C herein).

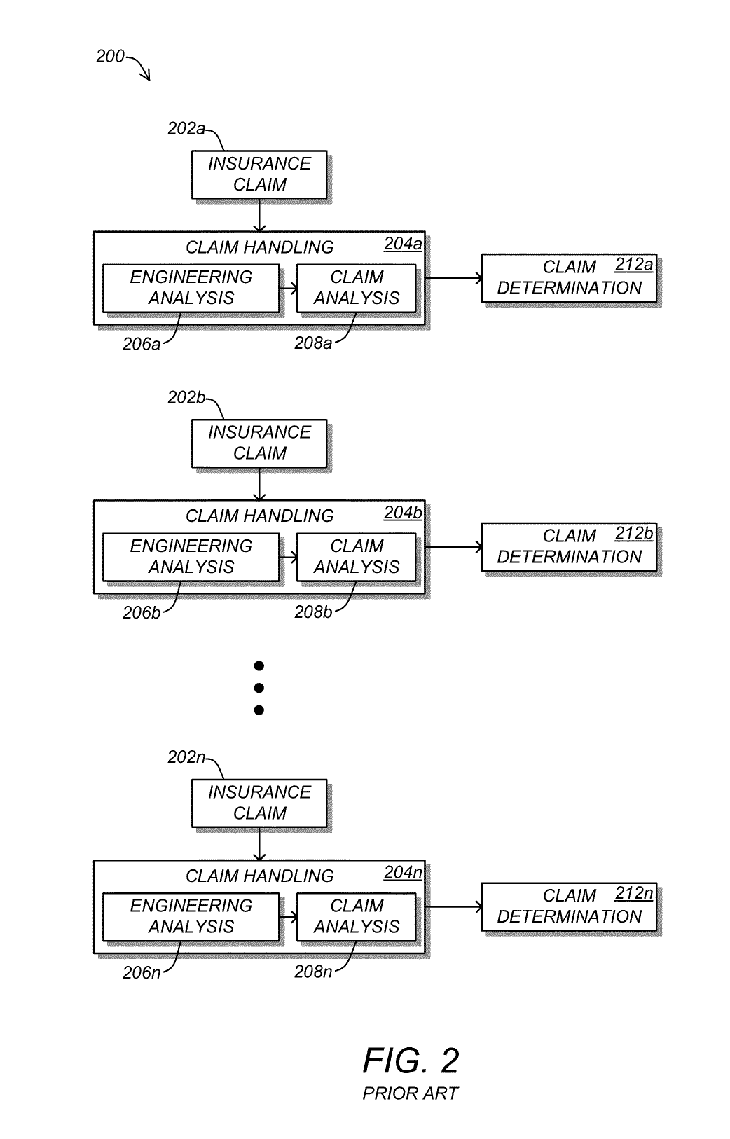

Referring now to FIG. 2, a flow diagram of a prior art method 200 is shown. The prior art method 200 is provided to illustrate, for example, how insurance claim handling utilizes engineering data in accordance with current practices. The method 200 may generally comprise receiving a plurality of insurance claims 202a-n. Each insurance claim 202a-n may generally be received and/or handled at 204a-n (e.g., “claim handling”). In many cases, each of the separate insurance claims 202a-n may be handled by a separate claim handler/adjuster (not shown in FIG. 2). The claim handling at 204a-n may generally comprise an engineering analysis 206a-n, such as in the case that the respective claim 202a-n involves engineering issues, such as a professional determination regarding whether a vibration event was the likely cause of certain damage and/or whether a particular sprinkler system likely malfunctioned and/or otherwise caused or contributed to loss or damage. In many cases, although not explicitly show in FIG. 2, the engineering analysis 206a-n may be conducted by various independent and/or third-party contractors and/or consultants, in-house engineering personnel, and/or a combination thereof.

In many cases, the engineering analysis 206a-n may be utilized to inform, conduct, and/or facilitate claim analysis 208a-n. A claim handler (not shown) may, for example, utilize results of the engineering analysis 206a-n, for example, to define, develop, calculate, identify, and/or otherwise determine a claim result at 212a-n (e.g., a “claim determination”). In the case that a first engineering analysis 206a indicates a low likelihood that the claimed loss/damage was due to an activity of an insured, for example, the first claim determination 212a may comprise an indication that the first claim 202a is denied. While the prior art method 200 is reasonably effective at leveraging engineering resources to assist in claim handling 204a-n, it suffers several deficiencies. Utilization of third-party consultants (not shown) may be a generally expensive proposition. Such consultants may appear to be necessary in many cases, however, due to an inability of a corporation to support a large, in-house, full-time engineering staff. Utilization of outside experts also generally tends to increase claim handling cycle times, as it adds communication inefficiencies and delays to the process (e.g., delays that could possibly be avoided or minimized if it were possible to conduct all engineering analysis 206a-n in-house). The prior art method 200 may also, for example, introduce inconsistencies into the claim handling process 204a-n. Different claim handlers may, for example, interpret and/or manage the engineering analysis 206a-n in different (and possibly even disparate) ways. Such inconsistencies are more likely to occur as the various claim handling 204a-n is conducted across distant geographic locations and/or as different third-party consultants are retained.

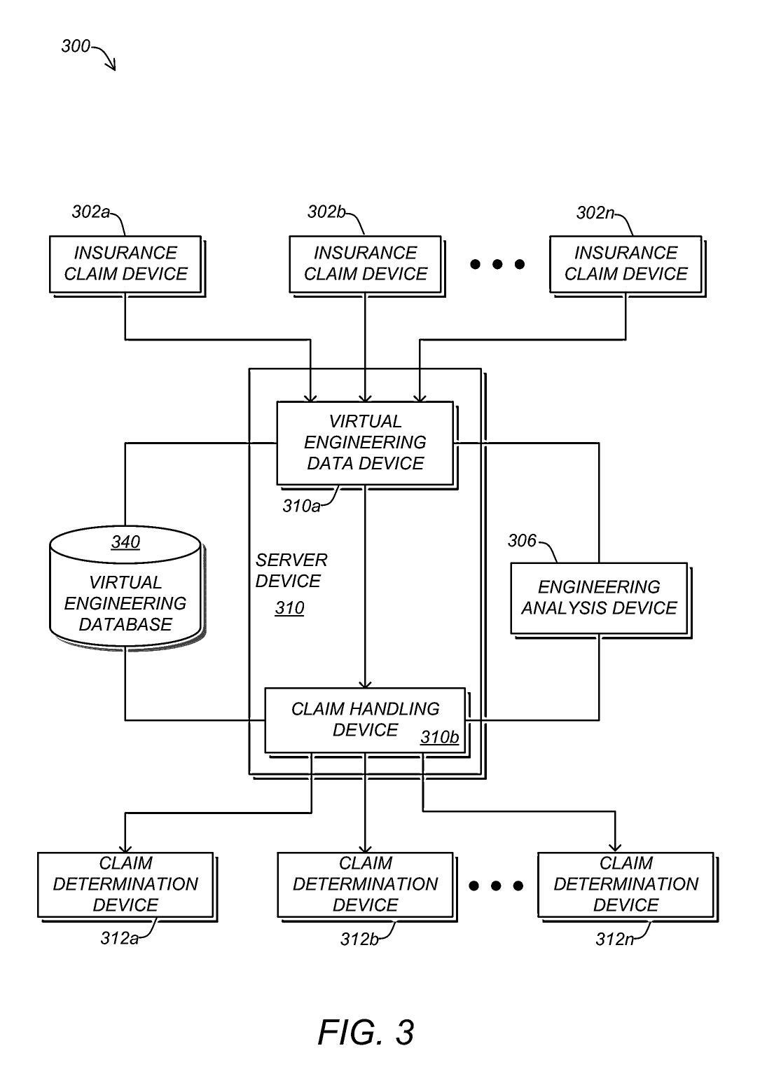

Turning to FIG. 3, a block diagram of a system 300 according to some embodiments is shown. In some embodiments, the system 300 may execute, process, facilitate, and/or otherwise be associated with the methods 500, 600, 700, 800, 1000 of FIG. 5, FIG. 6, FIG. 7, FIG. 8, and/or FIG. 10 and/or portions or combinations thereof described herein. In some embodiments, the system 300 may comprise one or more insurance claim devices 302a-n, an engineering analysis device 306, a server device 310 (e.g., comprising a virtual engineering data device 310a and/or a claim handling device 310b), one or more claim determination devices 312a-n, and/or a virtual engineering database 340. According to some embodiments, any or all of the components 302a-n, 306, 310a-b, 312a-n, 340 of the system 300 may be similar in configuration and/or functionality to any similarly named and/or numbered components described herein. Fewer or more components 302a-n, 306, 310a-b, 312a-n, 340 and/or various configurations of the components 302a-n, 306, 310a-b, 312a-n, 340 may be included in the system 300 without deviating from the scope of some embodiments described herein.

According to some embodiments, the system 300 may generally be utilized, configured, and/or otherwise disposed as a claim handling system. The insurance claim devices 302a-n may, for example, transmit and/or otherwise provide data descriptive of one or more insurance claims to the server device 310 (and/or to the virtual engineering data device 310a). In some embodiments, the insurance claim devices 302a-n may comprise any type, quantity, and/or configuration of electronic devices that are or become known or practicable. A first insurance claim device 302a may, for example, comprise a user and/or network device such as a PC or a mobile device (e.g., smart phone), while a second insurance claim device 302b may comprise a remote sensor device configured to monitor, record, store, and/or report data values for various engineering parameters (e.g., a telematic device and/or wireless sensor device).

In some embodiments, data received by the server device 310 (and/or by the virtual engineering data device 310a) from any or all of the insurance claim devices 302a-n may comprise data descriptive of values for engineering parameters associated with an insurance claim and/or data descriptive of one or more engineering and/or expert reports and/or determinations and/or claim liability data (e.g., an insurance claim determination, engineering analysis result, etc.). In some embodiments, the virtual engineering data device 310a may compile, rank, score, store, analyze, compress or decompress, encode and/or decode, and/or otherwise process the incoming engineering and/or claim data. The virtual engineering data device 310a may, for example, be utilized to conduct (and/or may conduct) data analysis and/or may determine (e.g., based on the incoming data) which engineering parameters and/or values or value ranges thereof are associated with and/or bear a mathematical relationship to one or more expert, engineering, and/or claim determinations. The virtual engineering data device 310a may, for example, determine that certain values of certain engineering parameters are related to certain claim liability data (e.g., certain loss exposure levels, certain claim determinations, etc.).

According to some embodiments, any or all incoming data and/or any or all determinations conducted by the virtual engineering data device 310a may be stored in the virtual engineering database 340. In some embodiments, incoming data (e.g., from the insurance claim devices 302a-n) may be compared to and/or aggregated or processed with data previously stored in the virtual engineering database 340. In some embodiments, the virtual engineering data device 310a may communicate with the engineering analysis device 306. In the case that raw engineering parameter value data is received from an insurance claim device 302a-n, for example, the engineering analysis device 306 may be consulted, activated, and/or otherwise utilized to conduct an engineering analysis and/or one or more engineering calculations based on such incoming data. Results thereof may be provided to (and/or received by) the virtual engineering data device 310a (e.g., in response to a query, request, and/or command sent by the virtual engineering data device 310a to the engineering analysis device 306). In some embodiments, the engineering analysis device 306 may comprise a third-party device and/or may be owned by, operated by and/or on behalf of, and/or accessible to an engineering consultant, contractor, and/or employee. According to some embodiments, any or all data received from the insurance claim devices 302a-n may be provided to the claim handling device 310b. Data and/or determinations from the virtual engineering data device 310a may also or alternatively be provided to the claim handling device 310b.

In some embodiments, such as in the case that incoming claim data is determined by the virtual engineering data device 310a to be associated with (and/or to have an identifiable data relationship with) a particular claim determination and/or liability level or result, an indication of such a determination and/or result may be provided to the claim handling device 310b. In the case that a claim handler (not shown) utilizes the claim handling device 310b to process incoming insurance claims, for example, the virtual engineering data device 310a may provide the claim handler with a suggested, recommended, and/or required claim analysis result. Incoming engineering data may indicate, for example (e.g., based on an analysis by the virtual engineering data device 310a and/or engineering analysis device 306 and/or based on data stored in the virtual engineering database 340), that a claimed loss could not have reasonably occurred as a result of an activity of an insured party (e.g., a likelihood and/or probability of the loss being related to the activity is low—i.e., below a predetermined probability threshold). It may accordingly be suggested and/or required, for example, that the claim be denied. In other cases the incoming engineering data may indicate that a connection between the claimed loss and the activity of the insured party cannot be ruled out. In those cases it may be suggested that the claim be referred for further review, investigation, and/or analysis, for example, by an engineer.

According to some embodiments, the claim handling device 310b may develop (and/or may be utilized to develop) a claim determination. In some embodiments, the claim handling device 310b may generally be utilized to conduct (and/or may automatically conduct) an investigation of an incoming insurance claim. Based on data received from the insurance claim devices 320a-n, the virtual engineering data device 310a, the engineering analysis device 306, and/or the virtual engineering database 340, for example, the claim handling device 310b may determine whether (and/or to what extent) a particular claim should be allowed, denied, referred for further review, etc.

In some embodiments, indications of the claim determination(s) may be provided to one or more of the claim determination devices 312a-n. The claim determination devices 312a-n may, for example, comprise one or more PC, wireless, and/or mobile electronic devices via which claim determination information is provided to customers, claimants, attorneys, an accounting department, insurance agent, broker, and/or Customer Service Representative (CSR), etc. According to some embodiments, the claim determination devices 312a-n may be similar to and/or comprise the insurance claim devices 302a-n. A single device may be utilized, in some embodiments for example, to submit an insurance claim (e.g., the first insurance claim device 302a) and receive an indication of a determination of the claim status (e.g., a first claim determination device 312a). In some embodiments, one or more of the insurance claim devices 302a-n and/or the claim determination devices 312a-n may comprise and/or be implemented via an online and/or Graphical User Interface (GUI), such as one or more of the example interfaces 1120a-c of FIG. 11A, FIG. 11B, and/or FIG. 11C herein.

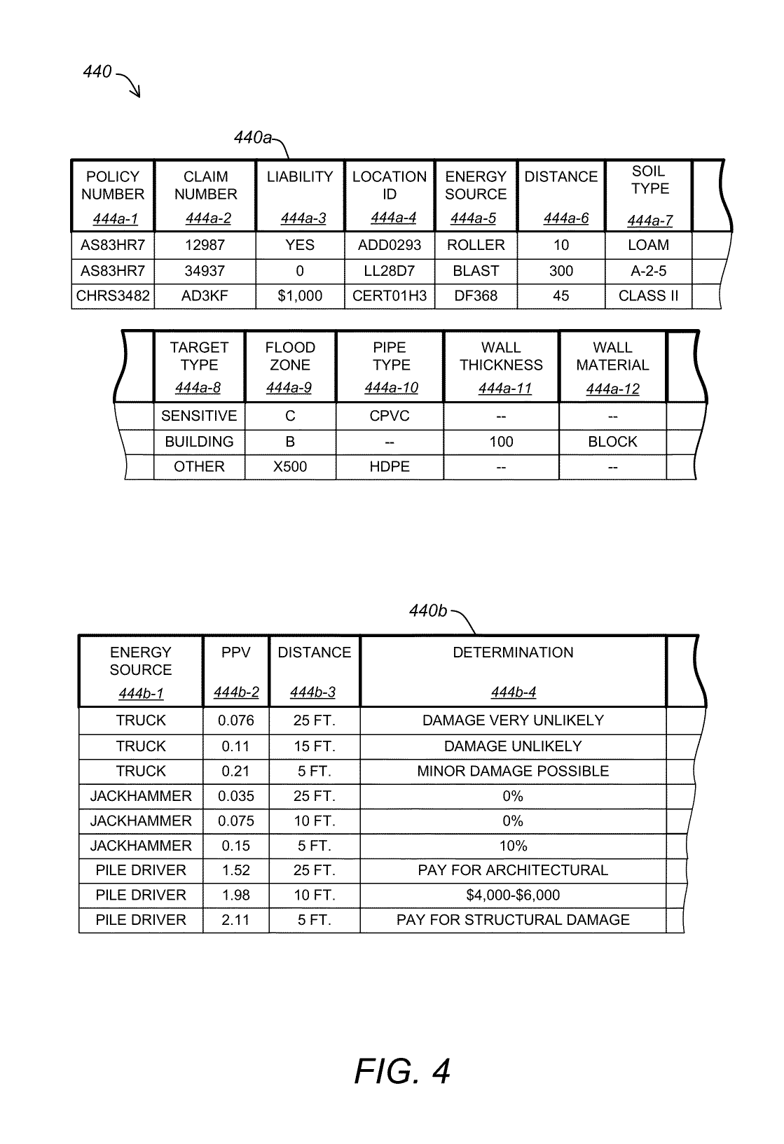

Referring now to FIG. 4, a diagram of an example data storage structure 440 according to some embodiments is shown. In some embodiments, the data storage structure 440 may comprise a plurality of data tables such as a claim data table 440a and/or a virtual engineering data table 440b. The data tables 440a-b may, for example, be utilized (e.g., at 506 and/or 510 of the method 500 of FIG. 5) to store, determine, and/or utilize various virtual engineering data (e.g., submitted by an insurance claim device 302a-n of FIG. 3), such as to assess claims for, price, quote, sell, renew, revise, and/or re-sell one or more underwriting products.

The claim data table 440a may comprise, in accordance with some embodiments, a policy number field 444a-1, a claim number field 444a-2, a liability field 444a-3, a location IDentifier (ID) field 444a-4, an energy source field 444a-5, a distance field 444a-6, a soil type field 444a-7, a target type field 444a-8, a flood zone field 444a-9, a pipe type field 444a-10, a wall thickness field 444a-11, and/or a wall material field 444a-12. Any or all of the number and/or ID fields 444a-1, 444a-2, 444a-4 may generally store any type of identifier that is or becomes desirable or practicable (e.g., a unique identifier, an alphanumeric identifier, and/or an encoded identifier). In some embodiments, the location ID field 444a-4 may comprise data descriptive and/or indicative of a certified location (e.g., a uniquely-identified geolocational point or object). The location ID field 444a-4 may, in some embodiments, store a certified location number, certificate number, code, and/or value as defined in commonly-assigned U.S. patent application Ser. No. 13/836,429 filed on Mar. 15, 2013 and titled “SYSTEMS AND METHODS FOR CERTIFIED LOCATION DATA COLLECTION, MANAGEMENT, AND UTILIZATION”, the certified location concepts and descriptions of which are hereby incorporated by reference herein. In such a manner, for example, engineering parameter values and/or data at a specific and/or unique geolocation may readily be determined.

In some embodiments, the policy number filed 444a-1 may store data indicative of an insurance policy and/or other underwriting product for which a claim is submitted and/or the claim number field 444a-2 may store an indication of one or more claims submitted for a given policy number. According to some embodiments, the liability field 444a-3 may store an indication of a claim determination or result, an engineering analysis report or result, and/or other expert conclusions and/or results. As depicted for exemplary purposes in FIG. 4, for example, the liability field 444a-3 may store an indication of “Yes” (e.g., indicating that there was liability determined to exist for the claim), “0” (e.g., indicating that there was no liability determined to exist and/or that the liability was equivalent to zero (0) dollars or a likelihood liability of zero (0), and/or one thousand dollars ($1,000)—e.g., indicating that the liability (believed to be due and/or paid out) for the claim was equal to the stored dollar amount. In some embodiments, such as in the case that a claim involves an alleged vibration damage event, the energy source field 444a-5 may store an indication of a type of energy source (e.g., a vibratory roller, jackhammer, truck, pile driver, etc.), the distance field 444a-6 may store an indication of a distance from or between the energy source and a “target” (e.g., an object subject to the claim of loss)—e.g., expressed in feet, meters, yards, etc.), the soil type field 444a-7 may store an indication of one or more types and/or classifications of soils (and/or other vibratory transmission mediums), e.g., between the energy source and the target, and/or the target type field 444a-8 may store an indication of a type of target subject to the claim (e.g., a residence, a commercial business, and/or a laboratory, historic structure, museum, and/or other more “sensitive” target).

According to some embodiments, the engineering parameter data stored in the claim data table 440a may comprise any type, quantity, and/or configuration of data and/or data fields that are or become known or practicable. While an example set of engineering parameters associated with vibratory event damage claims/losses is generally described herein for non-limiting exemplary purposes, for example, many other types of claims/losses and associated engineering parameters may also or alternatively be stored. In some embodiments, for example, engineering parameters may be associated with utility strike events, metal (and/or other) building collapse events, reactive aggregate events, mold events, paints and/or coatings events, expansive soils events, Chlorinated PolyVinyl Chloride (CPVC) pipe (and/or other pipe type) and/or materials events, sprinkler damage events, fire events, retaining wall failure (e.g., displacement, toppling, and/or collapse), ice dam events, concrete floor or wall (and/or other floor and/or wall material) failure events, wind events (e.g., commercial roof damage), dezincification events, galvanization events, and/or soil settlement events. In some embodiments, for example, the flood zone field 444a-9 may store an indication of one or more flood zones (e.g., FEMA flood zones) for a particular structure and/or property or other object, the pipe type field 444a-10 may store an indication of a pipe material associated with a claim, the wall thickness field 444a-11 may store an indication of a thickness (e.g., expressed in inches or centimeters) of a wall associated with a claim, and/or the wall material field 444a-12 may store an indication of a material type of a wall associated with a claim.

The virtual engineering data table 440b may comprise, in accordance with some embodiments, an energy source field 444b-1, a Peak Particle Velocity (PPV) field 444b-2, a distance field 444b-3, and/or a determination field 444b-4. Continuing the ongoing example of an insurance claim involving an alleged vibratory damage event, for example, the virtual engineering data table 440b may store indications relating various PPV values (stored in the PPV field 444b-2) to various corresponding claim and/or engineering determinations (stored in the determinations field 444b-4). As depicted, for example, a truck operating at a distance of twenty-five feet (25-ft.) from a target is very unlikely to cause any damage to the target. According to some embodiments, the determinations field 444b-4 may store qualitative claim and/or engineering determinations (e.g., “MINOR DAMAGE POSSIBLE”) and/or quantitative determinations (e.g., zero percent (0%) or ten percent (10%), representing a probability of damage, loss, and/or four to six thousand dollars ($4,000-$6,000), indicating a magnitude or range of likely loss/damage, etc.). In some embodiments, different data, such as different PPV values (and/or other engineering parameter values) and/or ranges, may define different determination thresholds (e.g., for different target types, energy sources, policy types, claimed loss magnitudes, soil types, etc.). In some embodiments, some or all of the data stored in the virtual engineering data table 440b may be derived, calculated, and/or otherwise determined based on some or all of the data stored in the claim data table 440a. Data from the claim data table 440a may, for example, be processed by a device (such as the server device 310 and/or the virtual engineering data device 310a of FIG. 3) to determine and/or store (e.g., in a database, such as the virtual engineering database 340 of FIG. 3 and/or the example data storage structure 440 of FIG. 4).

In some embodiments, fewer or more data fields than are shown may be associated with the data tables 440a-b. Only a portion of one or more databases and/or other data stores is necessarily shown in any of FIG. 4, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein nor imply that any such data is accurate.

Turning now to FIG. 5, a flow diagram of a method 500 according to some embodiments is shown. In some embodiments, the method 500 may be implemented, facilitated, and/or performed by or otherwise associated with the systems 100, 300 of FIG. 1 and/or FIG. 3 herein (and/or portions thereof, such as the controller device 110, the server device 310, the virtual engineering data device 310a and/or the claim handling device 310b). In some embodiments, the method 500 may be associated with the method 600 of FIG. 6. The method 500 may, for example, comprise a portion of the method 600, such as the claim processing 660.

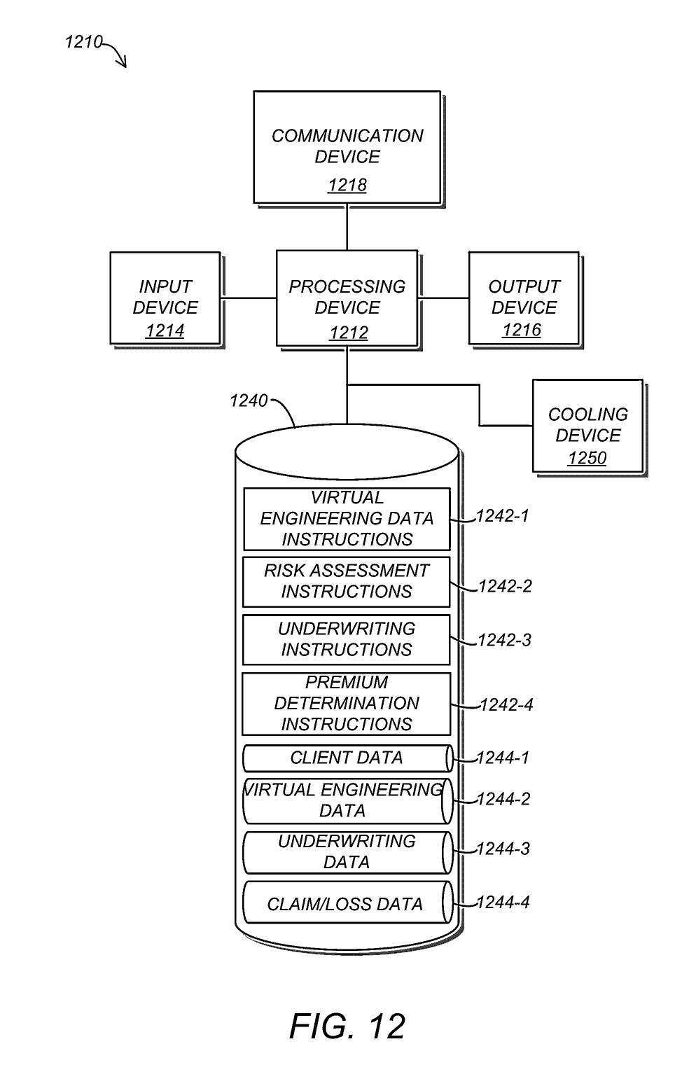

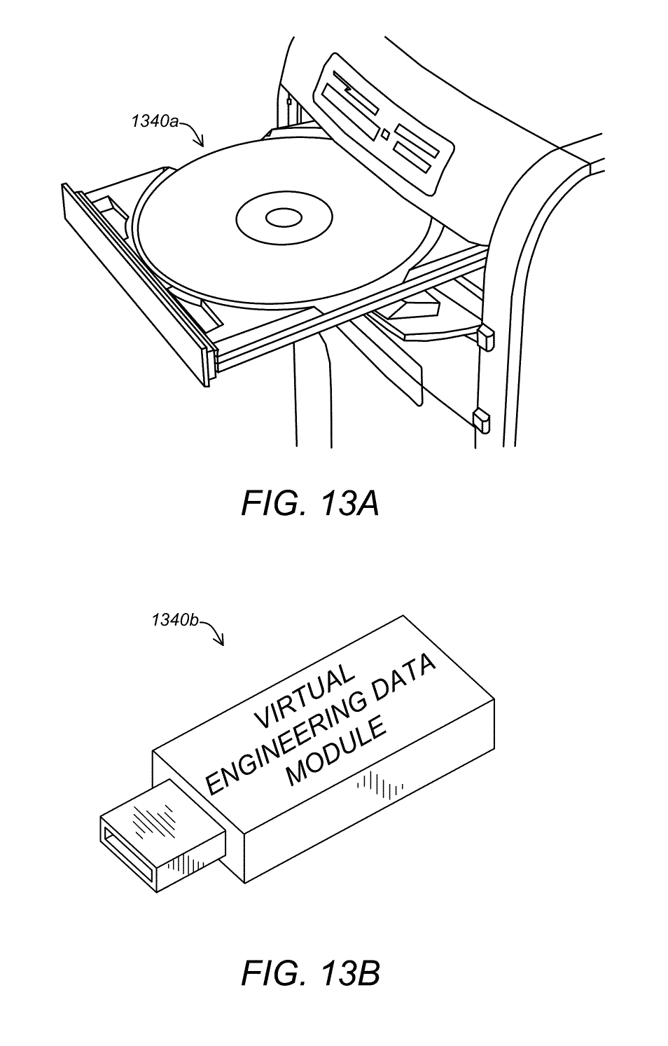

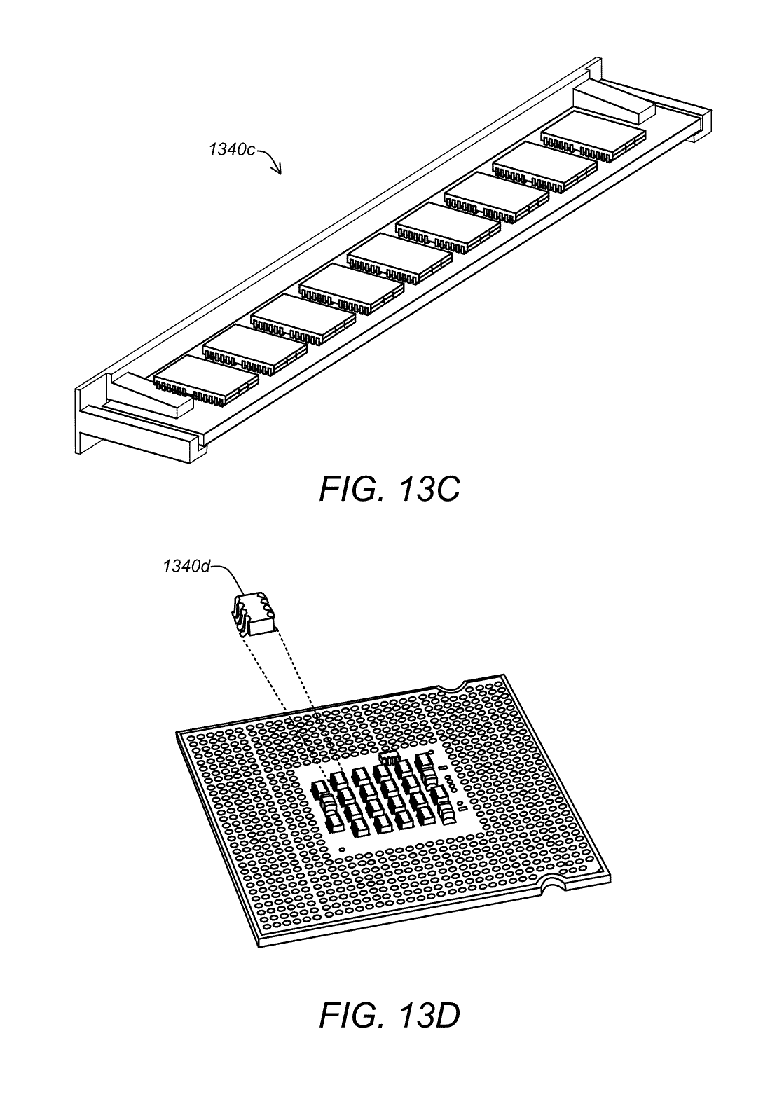

The process diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 340, 440, 1240, 1340a-d of FIG. 3, FIG. 4, FIG. 12, FIG. 13A, FIG. 13B, FIG. 13C, and/or FIG. 13D herein) may store thereon instructions that when executed by a machine (such as a computerized processor) result in performance according to any one or more of the embodiments described herein.

According to some embodiments, the method 500 may comprise receiving first insurance claim liability and engineering data, at 502. Such first liability data may comprise, for example, liability data, such as engineering reports and/or analysis results, claim handling determinations, and/or other expert conclusions and/or decisions. The first liability data may, in some embodiments, be received along with engineering parameter data, such as values of engineering parameters upon which such first liability data was at least partially based. In the context of the ongoing example of a first claim associated with an alleged vibration damage event, for example, data descriptive of the energy source (and/or magnitude), soil type (and/or other transmission medium type), target type, and/or distance from the source to the target may be received (e.g., from a first user device 102a of FIG. 1 and/or a first insurance claim device 302a of FIG. 3).

In some embodiments, the method 500 may comprise receiving second insurance claim liability and engineering data, at 504. Such second liability data and/or engineering parameter data may, for example, be similar to the first liability and/or engineering parameter data in that it may generally be descriptive of how and/or why a claim (i.e., the second insurance claim) was resolved (i.e., denied, allowed, referred, etc.). In some embodiments, the second data may be received from a different device and/or at a different (or even disparate) time with respect to the first data. The first claim may, for example, involve an alleged vibration-related damage event in Maryland, for which information is received (at 502) from an insurance agent's PC device located in Severna Park, Md., while the second claim may involve a soil settling (or sink hole)-related damage event in Florida, for which information is received (at 504) from a customer's mobile electronic device located in Punta Gorda, Fla. In some embodiments, any or all of the first and second data may be received via one or multiple transmission events and/or from one or multiple devices and/or entities. Liability data may be received from an agent or insurance company employee, for example, while associated engineering data may be received from an engineering entity such as a third-party engineering consultant service. In some embodiments, received data may be expressly input and/or selected for transmission (e.g., to a server device) by a user. In some embodiments, engineering parameter data (such as geolocation data and/or soils data) and/or liability data may be automatically determined and/or selected on behalf of the user (e.g., may be identified and/or determined by an application executed on a mobile electronic device utilizing geolocation, direction, altitude, and/or environmental data).

According to some embodiments, the method 500 may comprise storing the first and second insurance claim liability and engineering data, at 506. The data may be stored, for example, in a data storage structure such as the data storage structures 340, 440 of FIG. 3 and/or FIG. 4 herein, and/or in a portion thereof (such as in the claim data table 440a of FIG. 4). In some embodiments, the data may also be analyzed, ranked, sorted, compressed, decompressed, encoded, decoded, and/or otherwise processed. In some embodiments, the data may be utilized to define, calculate, generate, and/or otherwise determine one or more related data items and/or metrics. The first and second claim data may be stored in the example claim data table 440a (and/or a portion thereof) of FIG. 4, for example, and may be utilized to populate the virtual engineering data table 440b (and/or a portion thereof), such as a result of one or more analysis and/or calculation routines executed based on the first and/or second data. According to some embodiments, such as in the case both the first and second claims are associated with a single type of alleged damage event (e.g., a vibration event in accordance with the ongoing example herein), the first and second data may be compared to identify and/or determine one or more relationships between engineering parameters and/or parameter values (or ranges of values, such as PPV and distance to target values) and claim determinations. It may be determined, for example, that in the case of both the first and second claims (e.g., based on the information received at 502 and 504), PPV values above a certain threshold and within a certain distance of a vibration target are highly likely to cause architectural (e.g., aesthetic) damage to the target, which may equate to the respective claims having been allowed and/or paid out. According to some embodiments, any data received at 502 and/or 504 may be descriptive of “closed” and/or resolved first and second insurance claims (e.g., historic claim resolution data).

In some embodiments, the method 500 may comprise receiving third insurance claim engineering data, at 508. Claim information descriptive of engineering parameter values for an “open” or unresolved third claim may, for example, be received from an agent, claims adjuster, and/or engineering entity or device (e.g., a remote and/or automated sensor such as a seismic sensor configured for PPV detection and/or measurement). In some embodiments, the data received at 508 may be received via a different device and/or network than the data received at 502 and/or 504. Historic claims data (e.g., at 502 and 504) may be received via one or more backend systems and/or processes, for example, while active claim investigation data (e.g., at 508) may be received via a mobile device application and/or via a website (e.g., hosted by and/or in communication with a centralized server device). In some embodiments, the third data at 508 may be received via and/or identified or defined (e.g., via one or more drop-down and/or other GUI components) by a GUI claims investigation interface provided to claims adjusters (e.g., one or more of the example interfaces 1120a-c of FIG. 11A, FIG. 11B, and/or FIG. 11C herein).

According to some embodiments, the method 500 may comprise determining third insurance claim liability data, at 510. A comparison of the received third claim engineering data (e.g., at 508) to the stored data (e.g., at 506), for example, may yield an indication of whether or not the third insurance claim is likely to be valid (and/or to what extent). In some embodiments, a value of one or more engineering parameters associated with the third claim (e.g., received at 508) may be compared to a range of historic values for such one or more engineering parameters stored in a database (e.g., at 506). The comparison may identify one or more previous claims (e.g., the first and/or second insurance claims) that had engineering parameter values similar to that of the third insurance claim, and it may be assumed, calculated, looked up, and/or otherwise determined that liability data associated with such similar insurance claims may be utilized to describe the third insurance claim. Extending the ongoing example, in the case that the third insurance claim is associated with PPV, distance, and/or soil type data values that fall between those of the first and second insurance claims, it may be assumed that the liability of the third insurance claim may be described as a result that lies between the results of the two previous insurance claims. In such a case, for example, if both previous insurance claims were found to lack evidence of liability and the third insurance claim engineering parameter values lie between those of the two previous issuance claims, it may be assumed or determined that the third insurance claim should also be considered to lack evidence of liability. In such a manner, for example, increased costs of retaining an expert engineer may be avoided, allowing for increased profits, decreased cycle time, and/or a more consistent, centralized virtual engineering determination.

In some embodiments, the method 500 may comprise outputting an indication of a third insurance claim determination, at 512. Based on the third insurance claim liability determined at 510, for example, a determination of whether to allow, deny, or refer (or otherwise handle/adjust) the third insurance claim may be determined and output. A server device (e.g., that is associated with a provision of a claim handling website and/or application) may, for example, transmit and/or provide a signal to another device such as a user's PC and/or mobile device, causing the PC and/or mobile device to display and/or otherwise output the indication of the determination. According to some embodiments, the determination may be automatically defined and/or determined by the third insurance claim liability data. In the case that the third insurance claim liability data indicates that a likelihood of liability (e.g., a likelihood of an event of an insured having caused alleged damage/loss) is below a certain threshold, for example, the third insurance claim determination may be automatically determined to be a denial of the third insurance claim. In some embodiments, the third insurance claim liability data may instead cause a suggestion and/or recommendation of a particular determination (or range of determinations), and a user (e.g., a claim adjuster) may select and/or determine which ultimate determination should be applied to the third insurance claim.

Referring now to FIG. 6, a flow diagram of a method 600 according to some embodiments is shown. In some embodiments, the method 600 may be performed and/or implemented by and/or otherwise associated with one or more specialized and/or specially-programmed computers (e.g., the user devices 102a-n, the third-party device 106, and/or the controller device 110, all of FIG. 1 and/or the insurance claim devices 302-n, the engineering analysis device 306, the server device 310, the virtual engineering data device 310a, and/or the claim handling device 310b, all of FIG. 3), computer terminals, computer servers, computer systems and/or networks, and/or any combinations thereof (e.g., by one or more insurance company, claim handling, risk assessment, product sales, and/or underwriter computers).

According to some embodiments, the method 600 may comprise one or more actions associated with engineering data 602a-n. The engineering data 602a-n of one or more objects and/or areas that may be related to and/or otherwise associated with an account, customer, insurance product and/or policy (and/or a claim thereof), for example, may be determined, calculated, looked-up, retrieved, and/or derived. In some embodiments, the engineering data 602a-n may be gathered as raw data directly from one or more data sources (e.g., the user devices 102a-n of FIG. 1 and/or the insurance claim devices 302a-n of FIG. 3).

As depicted in FIG. 6, engineering data 602a-n from a plurality of data sources may be gathered. In some embodiments, the plurality of engineering data 602a-n may comprise information indicative of engineering parameter values of a single object or area or may comprise information indicative of engineering parameter values of a plurality of objects and/or areas and/or types of objects and/or areas. The engineering data 602a-n may, for example, be descriptive of structure characteristics, machinery characteristics, event characteristics (e.g., details descriptive of construction activities and/or events and/or details of weather events), soil types, flood zone, flood history, and/or other flood-related data (e.g., from a third-party data source such as the Federal Emergency Management Agency (FEMA) and/or CoreLogic® of Irvine, Calif.) and/or may comprise federal, state, regional, private, town/local, and/or municipal data reports, such as United States Geological Survey (USGS) topographic maps, United State Department of Agriculture (USDA) Natural Resource Conservation Service (NRCS) maps and/or data, and/or United States Army Corps of Engineers (USACE) maps, reports, permits, and/or studies.

According to some embodiments, the method 600 may also or alternatively comprise one or more actions associated with virtual engineering data processing 610. As depicted in FIG. 6, for example, some or all of the engineering data 602a-n may be determined, gathered, transmitted and/or received, and/or otherwise obtained for virtual engineering data processing 610. In some embodiments, virtual engineering data processing 610 may comprise aggregation, analysis, calculation, storing (e.g., in a data storage structure such as the data storage structures 340, 440 of FIG. 3 and/or FIG. 4 herein), filtering, conversion, encoding and/or decoding (including encrypting and/or decrypting), sorting, ranking, de-duping, and/or any combinations thereof.

According to some embodiments, a processing device may execute specially programmed instructions to process (e.g., the virtual engineering data processing 610) the engineering data 602a-n to define an engineering risk metric and/or index. Such an engineering risk metric may, for example, be descriptive (in a qualitative and/or quantitative manner) of historic, current, and/or predicted risk levels of an object and/or area having and/or being associated with one or more engineering risk characteristics. In some embodiments, the engineering risk metric may be time-dependent, time or frequency-based, and/or an average, mean, and/or other statistically normalized value (e.g., an index).

According to some embodiments, there may be a correlation between the risk level associated with a particular engineering risk (and/or set of engineering characteristics) and weather events when determining risk of loss. For example, a given risk level for an engineering risk and/or characteristic may correlate to a higher risk when there is ice, snow, or heavy slush likely to occur, than when only rain is expected (e.g., excessive roof loading on commercial and/or flat roofs due to snow weight).

In some embodiments, the method 600 may also or alternatively comprise one or more actions associated with insurance underwriting 620. Insurance underwriting 620 may generally comprise any type, variety, and/or configuration of underwriting process and/or functionality that is or becomes known or practicable. Insurance underwriting 620 may comprise, for example, simply consulting a pre-existing rule, criteria, and/or threshold to determine if an insurance product may be offered, underwritten, and/or issued to clients, based on any relevant engineering data 602a-n. One example of an insurance underwriting 620 process may comprise one or more of a risk assessment 630 and/or a premium calculation 640 (e.g., as shown in FIG. 6). In some embodiments, while both the risk assessment 630 and the premium calculation 640 are depicted as being part of an exemplary insurance underwriting 620 procedure, either or both of the risk assessment 630 and the premium calculation 640 may alternatively be part of a different process and/or different type of process (and/or may not be included in the method 600, as is or becomes practicable and/or desirable). In some embodiments, the engineering data 602a-n may be utilized in the insurance underwriting 620 and/or portions or processes thereof (the engineering data 602a-n may be utilized, at least in part for example, to determine, define, identify, recommend, and/or select a coverage type and/or limit and/or type and/or configuration of underwriting product). According to some embodiments, the engineering data 602a-n may be utilized as part of the insurance underwriting 620 to define, formulate, identify, construct, and/or otherwise determine a preventative or action plan that may for example, be utilized as a condition (or guidelines) for an insurance policy and/or other underwriting product. A liability policy in general, or with respect to one or more specific projects and/or activities for example, may be governed by the preventative plan which may include details regarding minimum distances from neighboring properties/structures at which certain equipment may be utilized, requirements for preventative measures such as installation of shielding and/or strengthening structures or supports, requirements for utilization and/or reporting of sensor data (e.g., seismograph and/or other sensor data), and/or requirements for various pre-activity documentation (e.g., requirements for types and/or quantities of pre-activity documentary photographs to be recorded, pre-activity sensor data, etc.).

In some embodiments, the engineering data 602a-n and/or a result of virtual engineering data processing 610 may be determined and utilized to conduct the risk assessment 630 for any of a variety of purposes. In some embodiments, the risk assessment 630 may be conducted as part of a rating process for determining how to structure an insurance product and/or offering. A “rating engine” utilized in an insurance underwriting process may, for example, retrieve an engineering risk metric (e.g., provided as a result of the virtual engineering data processing 610) for input into a calculation (and/or series of calculations and/or a mathematical model) to determine a level of risk or the amount of risky behavior likely to be associated with a particular object, event, activity, and/or area (e.g., being associated with one or more particular engineering characteristics). In some embodiments, the risk assessment 630 may comprise determining that a client views and/or utilizes engineering risk information (e.g., made available to the client via the insurance company and/or a third-party) and/or implements a certain preventative plan. In some embodiments, the risk assessment 630 (and/or the method 600) may comprise providing risk control recommendations (e.g., recommendations and/or suggestions directed to reduction of risk, premiums, loss, etc.), such as general or specific guidance and/or a preventative plan (whether formally tied to a policy as a requirement/condition or not).

According to some embodiments, the method 600 may also or alternatively comprise one or more actions associated with premium calculation 640 (e.g., which may be part of the insurance underwriting 620). In the case that the method 600 comprises the insurance underwriting 620 process, for example, the premium calculation 640 may be utilized by a “pricing engine” to calculate (and/or look-up or otherwise determine) an appropriate premium to charge for an insurance policy associated with the object, activity, event, and/or area for which the engineering data 602a-n was collected and for which the risk assessment 630 was performed. In some embodiments, the object, activity, event, and/or area analyzed may comprise an object, activity, event, and/or area for which an insurance product is sought (e.g., the analyzed activity may comprise a certain type of construction activity for which a liability insurance policy is desired or a business for which business insurance is desired). According to some embodiments, the object, activity, event, and/or area analyzed may be an object, activity, event, and/or area other than the object, activity, event, and/or area for which insurance is sought (e.g., the analyzed object may comprise a structure in proximity to a construction site on which the activity associated with an insurance policy will occur).

According to some embodiments, the method 600 may also or alternatively comprise one or more actions associated with insurance policy quote and/or issuance 650. Once a policy has been rated, priced, or quoted and the client has accepted the coverage terms (e.g., a preventative plan based on the engineering data 602a-n), the insurance company may, for example, bind and issue the policy by hard copy and/or electronically to the client/insured. In some embodiments, the quoted and/or issued policy may comprise a personal insurance policy, such as a property damage and/or liability policy, and/or a business insurance policy, such as a business liability policy, and/or a property damage policy.

In general, a client/customer may visit a website and/or an insurance agent, for example, may provide the needed information about the client and type of desired insurance, and request an insurance policy and/or product. According to some embodiments, the insurance underwriting 620 may be performed utilizing information about the potential client and the policy may be issued as a result thereof. Insurance coverage may, for example, be evaluated, rated, priced, and/or sold to one or more clients, at least in part, based on the engineering data 602a-n. In some embodiments, an insurance company may have the potential client indicate electronically, on-line, or otherwise whether they have any engineering risk, building, and/or location-sensing (e.g., telematics) devices (and/or which specific devices they have) and/or whether they are willing to install them or have them installed. In some embodiments, this may be done by check boxes, radio buttons, or other form of data input/selection, on a web page and/or via a mobile device application.

In some embodiments, the method 600 may comprise telematics data gathering, at 652. In the case that a client desires to have telematics data monitored, recorded, and/or analyzed, for example, not only may such a desire or willingness affect policy pricing (e.g., affect the premium calculation 640), but such a desire or willingness may also cause, trigger, and/or facilitate the transmitting and/or receiving, gathering, retrieving, and/or otherwise obtaining engineering data 602a-n from one or more telematics devices. As depicted in FIG. 6, results of the telematics data gathering at 652 may be utilized to affect the virtual engineering data processing 610, the risk assessment 630, and/or the premium calculation 640 (and/or otherwise may affect the insurance underwriting 620). Telematics data may be utilized, for example, to determine whether a preventative plan is being properly implemented and/or whether the preventative plan is adequate given the particular engineering data 602a-n associated with a particular object, activity, event, and/or area.

According to some embodiments, the method 600 may also or alternatively comprise one or more actions associated with claim processing 660. In the insurance context, for example, after an insurance product is provided and/or policy is issued (e.g., via the insurance policy quote and issuance 650), and/or during or after telematics data gathering 652, one or more insurance claims may be filed against the product/policy. In some embodiments, such as in the case that a first object associated with the insurance policy is somehow involved with one or more insurance claims, the engineering data 602a-n of the object or related objects may be gathered and/or otherwise obtained. According to some embodiments, such engineering data 602a-n may comprise data indicative of a level of risk of the object and/or area (or area in which the object was located) at the time of casualty or loss (e.g., as defined by the one or more claims). Information on claims may be provided to the virtual engineering data processing 610, risk assessment 630, and/or premium calculation 640 to update, improve, and/or enhance these procedures and/or associated software and/or devices. In some embodiments, engineering data 602a-n may be utilized to determine, inform, define, and/or facilitate a determination or allocation of responsibility related to a loss (e.g., the engineering data 602a-n may be utilized to determine an allocation of weighted liability amongst those involved in the incident(s) associated with the loss and/or otherwise determine a claim action, such as via the method 500 of FIG. 5 herein).

In some embodiments, the method 600 may also or alternatively comprise insurance policy renewal review 670. Engineering data 602a-n may be utilized, for example, to determine if and/or how an existing insurance policy (e.g., provided via the insurance policy quote and issuance 650) may be renewed. According to some embodiments, such as in the case that a client is involved with and/or in charge of (e.g., responsible for) providing the engineering data 602a-n (e.g., such as location data indicative of one or more particular property, project, activity, event, building, and/or structure attributes), a review may be conducted to determine if the correct amount, frequency, and/or type or quality of the engineering data 602a-n was indeed provided by the client during the original term of the policy. In the case that the engineering data 602a-n was lacking (and/or indicative of a violation of a preventative plan established for the policy), the policy may not, for example, be renewed and/or any discount received by the client for providing the engineering data 602a-n may be revoked or reduced. In some embodiments, the client may be offered a discount for having certain sensing devices or being willing to install them or have them installed (or be willing to adhere to certain thresholds based on measurements from such devices, e.g., in accordance with a preventative plan such as a vibratory damage preventative plan). In some embodiments, analysis of the received engineering data 602a-n in association with the policy may be utilized to determine if the client conformed to various criteria and/or rules set forth in the original policy. In the case that the client satisfied applicable policy requirements (e.g., as verified by received engineering data 602a-n), the policy may be eligible for renewal and/or discounts. In the case that deviations from policy requirements are determined (e.g., based on the engineering data 602a-n), the policy may not be eligible for renewal, a different policy may be applicable, and/or one or more surcharges and/or other penalties may be applied.

According to some embodiments, the method 600 may comprise one or more actions associated with risk/loss control 680. Any or all data (e.g., engineering data 602a-n and/or other data) gathered as part of a process for claims processing 660, for example, may be gathered, collected, and/or analyzed to determine how (if at all) one or more of a rating engine (e.g., the risk assessment 630), a pricing engine (e.g., the premium calculation 640), the insurance underwriting 620, and/or the virtual engineering data processing 610, should be updated to reflect actual and/or realized risk, costs, and/or other issues associated with the engineering data 602a-n. Results of the risk/loss control 680 may, according to some embodiments, be fed back into the method 600 to refine the risk assessment 630, the premium calculation 640 (e.g., for subsequent insurance queries and/or calculations), the insurance policy renewal review 670 (e.g., a re-calculation of an existing policy for which the one or more claims were filed), and/or the virtual engineering data processing 610 to appropriately scale the output of the risk assessment 630.

Turning now to FIG. 7, a flow diagram of a method 700 according to some embodiments is shown. In some embodiments, the method 700 may comprise a Virtual Engineering Data (VED) risk assessment method which may, for example, be described as a “rating engine”. According to some embodiments, the method 700 may be implemented, facilitated, and/or performed by or otherwise associated with the systems 100, 300 of FIG. 1 and/or FIG. 3 herein. In some embodiments, the method 700 may be associated with the method 600 of FIG. 6. The method 700 may, for example, comprise a portion of the method 600 such as the risk assessment 630.

According to some embodiments, the method 700 may comprise determining one or more loss frequency distributions for a class of objects, at 702 (e.g., 702a-b). In some embodiments, a first loss frequency distribution may be determined, at 702a, based on VED and/or VED metrics. VED (such as the engineering data 602a-n of FIG. 6) for a class of objects or actions such as a class of property or type of activity and/or for a particular type of object (such as a construction site near a museum) or a particular type of activity (such as blasting) within a class of objects/activates may, for example, be analyzed to determine relationships between various VED and/or VED metrics and empirical data descriptive of actual insurance losses for such object/activity types and/or classes of objects/activities. An engineering risk processing and/or analytics system and/or device (e.g., the controller device 110 and/or the server device 310 (or components thereof) as described with respect to FIG. 1 and/or FIG. 3 herein) may, according to some embodiments, conduct regression and/or other mathematical analysis on various engineering risk metrics to determine and/or identify mathematical relationships that may exist between such metrics and actual sustained losses and/or casualties.

Similarly, at 702b, a second loss frequency distribution may be determined based on non-VED. According to some embodiments, the determining at 702b may comprise a standard or typical loss frequency distribution utilized by an entity (such as an insurance company) to assess risk. The non-VED metrics utilized as inputs in the determining at 702b may include, for example, age of a building, proximity to emergency services, etc. In some embodiments, the loss frequency distribution determinations at 702a-b may be combined and/or determined as part of a single comprehensive loss frequency distribution determination. In such a manner, for example, expected total loss probabilities (e.g., taking into account both VED and non-VED) for a particular object and/or activity type and/or class may be determined. In some embodiments, this may establish and/or define a baseline, datum, average, and/or standard with which individual and/or particular risk assessments may be measured.

According to some embodiments, the method 700 may comprise determining one or more loss severity distributions for a class of objects, at 704 (e.g., 704a-b). In some embodiments, a first loss severity distribution may be determined, at 704a, based on VED and/or VED metrics. VED (such as the engineering data 602a-n of FIG. 6) for a class of objects and/or activities such as construction activities and/or for a particular type of object/activity (such as a drycleaner or window washing services) may, for example, be analyzed to determine relationships between various VED and/or VED metrics and empirical data descriptive of actual insurance losses for such object/activity types and/or classes of objects/activities. An engineering risk processing and/or analytics system (e.g., the controller device 110 and/or the server device 310 (or components thereof) as described with respect to FIG. 1 and/or FIG. 3 herein) may, according to some embodiments, conduct regression and/or other analysis on various (e.g., VED) metrics to determine and/or identify mathematical relationships that may exist between such metrics and actual sustained losses and/or casualties.

Similarly, at 704b, a second loss severity distribution may be determined based on non-VED. According to some embodiments, the determining at 704b may comprise a standard or typical loss severity distribution utilized by an entity (such as an insurance agency) to assess risk. The non-VED metrics utilized as inputs in the determining at 704b may include, for example, cost of replacement or repair, ability to self-mitigate loss (e.g., if a building has a fire suppression system and/or automatically closing fire doors, floor drains), etc. In some embodiments, the loss severity distribution determinations at 704a-b may be combined and/or determined as part of a single comprehensive loss severity distribution determination. In such a manner, for example, expected total loss severities (e.g., taking into account both VED and non-VED) for a particular object and/or activity type and/or class may be determined. In some embodiments, this may also or alternatively establish and/or define a baseline, datum, average, and/or standard with which individual and/or particular risk assessments may be measured.

In some embodiments, the method 700 may comprise determining one or more expected loss frequency distributions for a specific object and/or activity (and/or account or other group of objects or activities, such as a list of activities likely or expected in relations to a specific project) in the class of objects/activities, at 706 (e.g., 706a-b). Regression and/or other mathematical analysis performed on the VED loss frequency distribution derived from empirical data, at 702a for example, may identify various engineering risk metrics and may mathematically relate such metrics to expected loss occurrences (e.g., based on historical trends). Based on these relationships, a VED loss frequency distribution may be developed at 706a for the specific object and/or activity (and/or account or other group or list of objects or activities). In such a manner, for example, known engineering risk metrics for a specific object and/or activity (and/or account or other group or list of objects or activities) may be utilized to develop an expected distribution (e.g., probability) of occurrence of VED-related loss for the specific object and/or activity (and/or account or other group or list of objects or activities).

Similarly, regression and/or other mathematical analysis performed on the non-VED loss frequency distribution derived from empirical data, at 702b for example, may identify various non-VED metrics and may mathematically relate such metrics to expected loss occurrences (e.g., based on historical trends). Based on these relationships, a non-VED loss frequency distribution may be developed at 706b for the specific object and/or activity (and/or account or other group of objects or activities, such as a list of activities likely or expected in relations to a specific project). In such a manner, for example, known non-VED metrics for a specific object and/or activity (and/or account or other group or list of objects or activities) may be utilized to develop an expected distribution (e.g., probability) of occurrence of non-VED-related loss for the specific object and/or activity (and/or account or other group or list of objects or activities). In some embodiments, the non-VED loss frequency distribution determined at 706b may be similar to a standard or typical loss frequency distribution utilized by an insurer to assess risk.

In some embodiments, the method 700 may comprise determining one or more expected loss severity distributions for a specific object and/or activity (and/or account or other group of objects or activities, such as a list of activities likely or expected in relations to a specific project) in the class of objects/activities, at 708 (e.g., 708a-b). Regression and/or other mathematical analysis performed on the VED loss severity distribution derived from empirical data, at 704a for example, may identify various engineering risk metrics and may mathematically relate such metrics to expected loss severities (e.g., based on historical trends). Based on these relationships, a VED loss severity distribution may be developed at 708a for the specific object and/or activity (and/or account or other group or list of objects or activities). In such a manner, for example, known engineering risk metrics for a specific object and/or activity (and/or account or other group or list of objects or activities) may be utilized to develop an expected severity for occurrences of VED-related loss for the specific object and/or activity (and/or account or other group or list of objects or activities).

Similarly, regression and/or other mathematical analysis performed on the non-VED loss severity distribution derived from empirical data, at 704b for example, may identify various non-VED metrics and may mathematically relate such metrics to expected loss severities (e.g., based on historical trends). Based on these relationships, a non-VED loss severity distribution may be developed at 708b for the specific object and/or activity (and/or account or other group or list of objects or activities). In such a manner, for example, known non-VED metrics for a specific object and/or activity (and/or account or other group or list of objects or activities) may be utilized to develop an expected severity of occurrences of non-VED-related loss for the specific object and/or activity (and/or account or other group or list of objects or activities). In some embodiments, the non-VED loss severity distribution determined at 708b may be similar to a standard or typical loss frequency distribution utilized by an insurer to assess risk.

It should also be understood that the VED-based determinations 702a, 704a, 706a, 708a and non-VED-based determinations 702b, 704b, 706b, 708b are separately depicted in FIG. 7 for ease of illustration of one embodiment descriptive of how engineering risk metrics may be included to enhance standard risk assessment procedures. According to some embodiments, the VED-based determinations 702a, 704a, 706a, 708a and non-VED-based determinations 702b, 704b, 706b, 708b may indeed be performed separately and/or distinctly in either time or space (e.g., they may be determined by different software and/or hardware modules or components and/or may be performed serially with respect to time). In some embodiments, VED-based determinations 702a, 704a, 706a, 708a and non-VED-based determinations 702b, 704b, 706b, 708b may be incorporated into a single risk assessment process or “engine” that may, for example, comprise a risk assessment software program, package, and/or module.

In some embodiments, the method 700 may also comprise calculating a risk score (e.g., for an object, account, activity, event, and/or group or list of objects/activities, e.g., objects/activities related in a manner other than sharing an identical or similar class designation), at 710. According to some embodiments, formulas, charts, and/or tables may be developed that associate various VED and/or non-VED metric magnitudes with risk scores. Risk scores for a plurality of VED and/or non-VED metrics may be determined, calculated, tabulated, and/or summed to arrive at a total risk score for an object, activity, event, and/or account (e.g., a property, a property feature, a portfolio and/or group of properties and/or objects subject to engineering risk) and/or for an object or activity class. According to some embodiments, risk scores may be derived from the VED and/or non-VED loss frequency distributions and the VED and/or non-VED loss severity distribution determined at 706a-b and 708a-b, respectively. More details on one method for assessing risk are provided in commonly-assigned U.S. Pat. No. 7,330,820 entitled “PREMIUM EVALUATION SYSTEMS AND METHODS,” which issued on Feb. 12, 2008, the risk assessment concepts and descriptions of which are hereby incorporated by reference herein.

In some embodiments, the method 700 may also or alternatively comprise providing various recommendations, suggestions, guidelines, and/or rules directed to reducing and/or minimizing risk, premiums, etc. According to some embodiments, the results of the method 700 may be utilized to determine a premium for an insurance policy for, e.g., a specific object, activity, project, and/or account analyzed. Any or all of the VED and/or non-VED loss frequency distributions of 706a-b, the VED and/or non-VED loss severity distributions of 708a-b, and the risk score of 710 may, for example, be passed to and/or otherwise utilized by a premium calculation process via the node labeled “A” in FIG. 7.

Turning to FIG. 8, for example, a flow diagram of a method 800 (that may initiate at the node labeled “A”) according to some embodiments is shown. In some embodiments, the method 800 may comprise a VED-based premium determination method which may, for example, be described as a “pricing engine”. According to some embodiments, the method 800 may be implemented, facilitated, and/or performed by or otherwise associated with the systems 100, 300 of FIG. 1 and/or FIG. 3 herein. In some embodiments, the method 800 may be associated with the method 600 of FIG. 6. The method 800 may, for example, comprise a portion of the method 600 such as the premium calculation 640. Any other technique for calculating an insurance premium that uses VED described herein may be utilized, in accordance with some embodiments, as is or becomes practicable and/or desirable.

In some embodiments, the method 800 may comprise determining a pure premium, at 802. A pure premium is a basic, unadjusted premium that is generally calculated based on loss frequency and severity distributions. According to some embodiments, the VED and/or non-VED loss frequency distributions (e.g., from 706a-b in FIG. 7) and the VED and/or non-VED loss severity distributions (e.g., from 708a-b in FIG. 7) may be utilized to calculate a pure premium that would be expected, mathematically, to result in no net gain or loss for the insurer when considering only the actual cost of the loss or losses under consideration and their associated loss adjustment expenses. Determination of the pure premium may generally comprise simulation testing and analysis that predicts (e.g., based on the supplied frequency and severity distributions) expected total losses (VED-based and/or non-VED-based) over time.

According to some embodiments, the method 800 may comprise determining an expense load, at 804. The pure premium determined at 802 does not take into account operational realities experienced by an insurer. The pure premium does not account, for example, for operational expenses such as overhead, staffing, taxes, fees, etc. Thus, in some embodiments, an expense load (or factor) is determined and utilized to take such costs into account when determining an appropriate premium to charge for an insurance product. According to some embodiments, the method 800 may comprise determining a risk load, at 806. The risk load is a factor designed to ensure that the insurer maintains a surplus amount large enough to produce an expected return for an insurance product.

According to some embodiments, the method 800 may comprise determining a total premium, at 808. The total premium may generally be determined and/or calculated by summing or totaling one or more of the pure premium, the expense load, and the risk load. In such a manner, for example, the pure premium is adjusted to compensate for real-world operating considerations that affect an insurer.

According to some embodiments, the method 800 may comprise grading the total premium, at 810. The total premium determined at 808, for example, may be ranked and/or scored by comparing the total premium to one or more benchmarks. In some embodiments, the comparison and/or grading may yield a qualitative measure of the total premium. The total premium may be graded, for example, on a scale of “A”, “B”, “C”, “D”, and “F”, in order of descending rank. The rating scheme may be simpler or more complex (e.g., similar to the qualitative bond and/or corporate credit rating schemes determined by various credit ratings agencies such as Standard & Poors' (S&P) Financial service LLC, Moody's Investment Service, and/or Fitch Ratings from Fitch, Inc., all of New York, N.Y.) of as is or becomes desirable and/or practicable. More details on one method for calculating and/or grading a premium are provided in commonly-assigned U.S. Pat. No. 7,330,820 entitled “PREMIUM EVALUATION SYSTEMS AND METHODS” which issued on Feb. 12, 2008, the premium calculation and grading concepts and descriptions of which are hereby incorporated by reference herein.

According to some embodiments, the method 800 may comprise outputting an evaluation, at 812. In the case that the results of the determination of the total premium at 808 are not directly and/or automatically utilized for implementation in association with an insurance product, for example, the grading of the premium at 810 and/or other data such as the risk score determined at 710 of FIG. 7 may be utilized to output an indication of the desirability and/or expected profitability of implementing the calculated premium. The outputting of the evaluation may be implemented in any form or manner that is or becomes known or practicable. One or more recommendations, graphical representations, visual aids, comparisons, and/or suggestions may be output, for example, to a device (e.g., a server and/or computer workstation) operated by an insurance underwriter and/or sales agent. One example of an evaluation comprises a creation and output of a risk matrix which may, for example, by developed utilizing Enterprise Risk Register® software which facilitates compliance with ISO 17799/ISO 27000 requirements for risk mitigation and which is available from Northwest Controlling Corporation Ltd. (NOWECO) of London, UK.

Referring to FIG. 9, for example, a diagram of an exemplary risk matrix 900 according to some embodiments is shown. In some embodiments (as depicted), the risk matrix 900 may comprise a simple two-dimensional graph having an X-axis and a Y-axis. Any other type of risk matrix, or no risk matrix, may be used if desired. The detail, complexity, and/or dimensionality of the risk matrix 900 may vary as desired and/or may be tied to a particular insurance product or offering. In some embodiments, the risk matrix 900 may be utilized to visually illustrate a relationship between the risk score (e.g., from 630 of FIG. 6 and/or from 710 of FIG. 7) of an object and/or activity (and/or account and/or group or list of objects/activities) and the total determined premium (e.g., from 640 of FIG. 6 and/or 808 of FIG. 8; and/or a grading thereof, such as from 810 of FIG. 8) for an insurance product offered in relation to the object and/or activity (and/or account and/or group or list of objects/activities). As shown in FIG. 9, for example, the premium grade may be plotted along the X-axis of the risk matrix 900 and/or the risk score may be plotted along the Y-axis of the risk matrix 900.

In such a manner, the risk matrix 900 may comprise four (4) quadrants 902a-d (e.g., similar to a “four-square” evaluation sheet utilized by automobile dealers to evaluate the propriety of various possible pricing “deals” for new automobiles). The first quadrant 902a represents the most desirable situations where risk scores are low and premiums are highly graded. The second quadrant 902b represents less desirable situations where, while premiums are highly graded, risk scores are higher. Generally, object-specific data that results in data points being plotted in either of the first two quadrants 902a-b is indicative of an object for which an insurance product may be offered on terms likely to be favorable to the insurer. The third quadrant 902c represents less desirable characteristics of having poorly graded premiums with low risk scores and the fourth quadrant 902d represents the least desirable characteristics of having poorly graded premiums as well as high risk scores. Generally, object-specific data that results in data points being plotted in either of the third and fourth quadrants 902c-d is indicative of an object for which an insurance product offering is not likely to be favorable to the insurer.

One example of how the risk matrix 900 may be output and/or implemented with respect to VED of an account and/or group of objects will now be described. Assume, for example, that a business liability insurance policy is desired by a consumer and/or that a business liability insurance policy product is otherwise analyzed to determine whether such a policy would be beneficial for an insurer to issue. Typical risk metrics such as the type of business (e.g., a business classification), the number of employees, and/or the gross receipts of the business may be utilized to produce expected loss frequency and loss severity distributions (such as determined at 706b and 708b of FIG. 7).

In some embodiments, VED metrics associated with the business, account, and/or one or more specific projects that the business desires to insure (i.e., the objects/activities being insured), such as an expected PPV for a particular construction project (relative to one or more particular targets), may also be utilized to produce expected VED loss frequency and VED loss severity distributions (such as determined at 706a and 708a of FIG. 7). According to some embodiments, singular loss frequency and loss severity distributions may be determined utilizing both typical risk metrics, as well as VED metrics (of the activity being insured and/or of other associated objects/activities, such as other properties/businesses/activities belonging to and/or associated with the same account, sub-account, etc.).

In the case that the engineering risk score for the account is greater than a certain predetermined magnitude (e.g., threshold), based on expected PPV for example, the risk score for the activity and/or account may be determined to be relatively high, such as seventy-five (75) on a scale from zero (0) to one hundred (100), as compared to a score of fifty (50) for a second engineering risk score (e.g., based on different VED such as a different soil type, in the case of vibration event analysis). Other non-VED factors such as the loss history for the account/object(s)/activity (and/or other factors) may also contribute to the risk score for the consumer, account, activity, project, and/or insurance product associated therewith.

The total premium calculated for a potential insurance policy offering covering the property/account/object(s)/activity (e.g., determined at 808 of FIG. 8) may, to continue the example, be graded between “B” and “C” (e.g., at 810 of FIG. 8) or between “Fair” and “Average”. The resulting combination of risk score and premium rating may be plotted on the risk matrix 900, as represented by a data point 904 shown in FIG. 9. The data point 904, based on the VED-influenced risk score and the corresponding VED-influenced premium calculation, is plotted in the second quadrant 902b, in a position indicating that while the risk of insuring the property/account/object(s)/activity is relatively high, the calculated premium is probably large enough to compensate for the level of risk. In some embodiments, an insurer may accordingly look favorably upon issuing such as insurance policy to the client to cover the property/account/object(s)/activity in question and/or may consummate a sale of such a policy to the consumer (e.g., based on the evaluation output at 812 of FIG. 8, such as decision and/or sale may be made).

Turning to FIG. 10, a flow diagram of a method 1000 according to some embodiments is shown. In some embodiments, the method 1000 may comprise a virtual engineering data risk assessment, underwriting, and/or product sales method. According to some embodiments, the method 1000 may be implemented, facilitated, and/or performed by or otherwise associated with the systems 100, 300 of FIG. 1 and/o FIG. 3 herein. In some embodiments, the method 1000 may be associated with the method 600 of FIG. 6. The method 1000 may, for example, comprise a portion of the method 600 such as the virtual engineering data processing 610, the insurance underwriting 620, the risk assessment 630, the premium calculation 640, and/or the insurance policy quote and issuance 650.

In some embodiments, the method 1000 may comprise determining an engineering risk parameter value for a first insurance policy, at 1002. An insured, applicant, customer, and/or device (e.g., a telematics device and/or other sensor) may, for example, provide data descriptive of one or more engineering values associated with an object, area, event, activity, account, policy, etc. In the context of the ongoing construction-related vibration analysis, for example, a field agent or customer (or devices related thereto) may provide an indication of a recorded or expected PPV, a distance to a potential vibration target, and/or soil type information for a particular area. In the case that the information is provided from a mobile electronic device and/or sensor, certain data may be automatically derived and/or looked up based on the received information. A customer utilizing a smart phone may, for example, provide location information (e.g., Global Positioning System (GPS) data, cellular network data, etc.) via which local and/or relevant soil types and/or potential targets and/or distances thereto may be determined. The first insurance policy may comprise an existing policy or a policy for which a quote is desired.

According to some embodiments, the method 1000 may comprise determining stored information descriptive of the engineering risk parameter with respect to a second insurance policy, at 1004. The value of the received parameter at 1002, for example, may be utilized to query one or more databases to determine data related thereto. In some embodiments, the related data may comprise liability data. An engineering value, such as a distance to a nearby museum (with respect to a proposed insured activity) received with respect to the first insurance policy, for example, may be utilized to determine other insurance policies (such as the second insurance policy) that had or experienced a similar or comparable (e.g., within the same range of values) distance to a similar target. According to some embodiments, such a related or comparable policy may be or have been associated with an insurance claim applicable to the received engineering risk parameter. The museum with respect to the second insurance policy, for example, may have been determined to have been damaged by a construction-related vibration event covered by the second insurance policy (and having a similar distance to the vibration target). Related information from the second insurance policy such as soil type and/or energy source type may be determined and/or identified.

In some embodiments, the method 1000 may comprise determining a risk metric for the first insurance policy based on a comparison of the engineering risk parameter value and the stored information, at 1006. The stored information determined to have some relationship to the received information may, for example, be utilized to determine a likelihood that an activity/event with respect to the first insurance policy is likely to cause damage (and/or to what extent). In the example case that the museum associated with a claim on the second insurance policy was damaged by an impact pile driver one hundred feet (100-ft.) from the museum and through a clay-loam soil, for example, it may be determined what the likelihood is that a comparable activity will result in damage/loss over a similar distance but through a silty-clay soil. In some embodiments such as in the case that multiple other insurance policy data is determined to be related to the received value, regression, extrapolation, and/or other quantitative analysis may be conducted to determine a level of expected or estimated risk associated with the received value. In some embodiments, the stored data may comprise VED as described and/or as utilized herein.

According to some embodiments, the method 1000 may comprise determining an insurance premium for the first insurance policy based on the risk metric of the first insurance policy, at 1008. The level of expected risk associated with the received value (e.g., based on stored VED) may be utilized, for example, to determine an appropriate premium level for an insurance product covering a proposed entity, activity, and/or object, as described herein. According to some embodiments, a preventative plan may be selected and/or developed based on the received value and/or associated VED. In some embodiments, the premium may be at least partially based on an assumption that the preventative plan will be implemented. In some embodiments, the method 1000 may comprise outputting an indication of the insurance premium, at 1010. The insurance premium may be quoted to a potential customer and/or agent, for example, such as by transmitting an indication (e.g., of the price of the premium and/or including details of a preventative plan) via e-mail, text message, via a GUI and/or other interface (e.g., via the web and/or via a kiosk) and/or other means. According to some embodiments, the method 1000 may comprise selling the first insurance policy, at 1012. In the case that the potential customer accepts the proposed premium, for example, data may be exchanged consummating a transaction and/or facilitating or causing a transaction to take place where funds are exchanged in consideration for coverage under the quoted policy.

Turning to FIG. 11A, FIG. 11B, and FIG. 11C, example interfaces 1120a-c according to some embodiments are shown. In some embodiments, the interfaces 1120a-c may comprise a web page, web form, database entry form, Application Programming Interface (API), spreadsheet, table, and/or application or other Graphical User Interface (GUI) via which a claim handler/adjuster and/or other entity may enter, review, and/or analyze VED, and/or via which a user may utilize and/or apply VED to conduct claim investigations and/or facilitate product underwriting (and/or portions thereof such as risk assessments and/or preventative plan development and/or management). The interfaces 1120a-c may, for example, comprise a front-end of claim handling program (and/or portion thereof) and/or platform programmed and/or otherwise configured to execute, conduct, and/or facilitate any of the various methods 500, 600, 700, 800, 1000 of FIG. 5, FIG. 6, FIG. 7, FIG. 8, and/or FIG. 10 and/or portions or combinations thereof described herein. In some embodiments, the interfaces 1120a-c may be output via a computerized device such as one or more of the user devices 102a-n and/or the controller device 110 of FIG. 1 and/or the claim determination devices 312a-n and/or the server device 310 (or components thereof) of FIG. 3 herein. In some embodiments, the example interfaces 1120a-c may comprise interface outputs of (and/or otherwise associated with) a GUI utilized to research, analyze, resolve, and/or investigate an insurance and/or underwriting product claim and/or to price, quote, purchase/sell, re-sell, and/or otherwise configure an underwriting product, such as may be implemented and/or provided as described herein.

A first example interface 1120a as depicted in FIG. 11A, for example, may provide a menu 1122 of options relating to one or more specific claim handling and/or investigation topics and/or issues, such as the analysis of construction-related vibration damage claims as depicted for non-limiting exemplary purposes in FIG. 11A. In some embodiments, the menu 1122 may comprise links to various topics and/or data such as a background information section 1124, a best practices section 1126, and/or an expert management section 1128. Selection of any link/portion of any such section 1124, 1126, 1128 by a user (and/or a receipt of an indication of such a selection by a processing device associated with the first example interface 1120a) may, for example, cause an outputting and/or providing of information related to the selected link/portion.

The background information section 1124 may, for example, link to and/or provide access to information descriptive of issues relating to construction and/or vibratory damage claims analysis. Such information may, for example, provide a level of detail regarding the engineering parameters and/or concepts that are important to an engineering analysis and/or determination regarding vibration claim issues. In such a manner, for example, should a claim handler be provided with the background information 1124, certain claim analysis issues (e.g., simple or basic engineering issues) may be understood (or even resolved) by the claim handler, e.g., without requiring the expense of hiring an engineering consultant.

According to some embodiments, the best practices section 1126 may link to and/or provide access to information descriptive of one or more guidelines, rules, and/or criteria relating to construction and/or vibration claim handling practices. Such information may, for example, provide a centralized repository where a diverse group of distributed claim handlers can (and/or are required to) access, learn, and/or follow standardized company claim handling procedures, e.g., with respect to specific engineering issues such as the example vibration analysis. In such a manner, for example, inefficiencies and/or unnecessary practices may be minimized or prevented, resulting in decreased cycle times for claim handling and decreased costs for such processes.

In to some embodiments, the expert management section 1128 may link to and/or provide access to information descriptive of one or more guidelines, rules, and/or criteria relating to how external experts should be retained, handled, managed, and/or what expectations should be applicable to work product from such experts. Such information may, for example, provide guidance to claim handlers dealing with experts and/or expert analysis or reports from a large magnitude of diverse experts and/or organizations (e.g., throughout the country or even worldwide). In such a manner, for example, engineering data requested and/or received from a wide variety of expert and/or reference sources may be standardized which may, for example, allow for more efficient aggregation, identification, processing, and/or determination of VED as described herein.

In some embodiments, a second example interface 1120b as depicted in FIG. 11B may also or alternatively provide analysis options to a user. The second example interface 1120b may, for example, provide an energy source selector 1130 that allows a user to select one or more energy sources (in the context of the continuing example of a vibration-based claim) applicable to an insurance claim (and/or policy). As depicted in FIG. 11B for example, a selected energy source 1132 may comprise an impact pile driver (and/or specific make, model, configuration, and/or usage type thereof). The second example interface 1120b may, in some embodiments, provide a PPV indicator chart 1134 that displays excepted and/or estimated PPV values (or other engineering metrics, as are or become applicable) for the selected energy source 1132 (e.g., at a specific range or distance, such as the example twenty-five feet (25 ft.) in FIG. 11B). The selected energy source 1132 (impact pile driver) may, for example, be depicted as having an expected PPV range 1136 of between 0.644 and 1.518 inches per second. As illustrated in the PPV indicator chart 1134, a qualitative identifier may be assigned and/or displayed with respect to one or more portions of the PPV indicator chart 1134. The expected PPV range 1136 of the selected energy source 1132, for example, may be described as being associated with an increasing likelihood (e.g., from left to right on the PPV indicator chart 1134) of architectural damage occurring as a result of utilization of the selected energy source 1132 (e.g., at a selected and/or applicable distance, with respect to a certain selected and/or applicable type of target, and/or with respect to a selected and/or applicable soil type).

According to some embodiments, a third example interface 1120c as depicted in FIG. 11C may also or alternatively provide a graph 1140 depicting PPV at various distances/ranges. The graph 1140 may be provided, for example, based on engineering and/or VED for a specific claim, policy, project, activity, object, etc. In some embodiments, the graph 1140 may comprise a plot 1142 of PPV versus distance for a particular energy source type (e.g., the selected energy source 1132 of the second example interface 1120b of FIG. 11B) for a vibratory roller as shown. The graph 1140 may, in some embodiments, comprise a visual indication of a threshold 1144. The threshold 1144 may, for example, comprise a threshold above which a claim may be deemed to be valid, potentially valid, and/or likely beyond a particular predetermined probability value. In such a manner, for example, a user may utilize the third example interface 1120c to identify an appropriate claim determination based on claim-specific data. As depicted in the example of FIG. 11C, for example, a known distance 1146 to a target may be utilized (and/or plotted) to determine a claim-specific PPV 1148. In the depicted example, the claim-specific PPV 1148 of 0.028 inches per second is far below the threshold 1144 of 0.20 inches per second, indicating, for example, that a claim of damage from the activity in question with respect to the target is highly unlikely to be valid. In some embodiments, such liability data may be utilized to develop and/or may cause a selection of a particular claim determination, e.g., the claim in question is denied.

While the example interfaces 1120a-c are depicted herein with respect to a specific example of an insurance product policy claims and/or underwriting process, other products, risk assessments, searches, and/or other assessments may be provided in accordance with some embodiments. While the depicted claim handling investigation and/or determination comprises a review of VED related to vibratory damage claims, for example, assessment of other claims and/or metrics may also or alternatively be utilized by and/or incorporated into the interfaces 1120a-c.

While various components of the interfaces 1120a-c have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Referring to FIG. 12, a block diagram of an apparatus 1210 according to some embodiments is shown. In some embodiments, the apparatus 1210 may be similar in configuration and/or functionality to any of the controller device 110, the user devices 102a-n, and/or the third-party device 106, all of FIG. 1 herein and/or the insurance claim devices 302a-n, the engineering analysis device 306, the server device 310 (and/or components thereof), and/or the claim determination devices 312a-n, all of FIG. 3 herein. The apparatus 1210 may, for example, execute, process, facilitate, and/or otherwise be associated with the methods 500, 600, 700, 800, 1000 of FIG. 5, FIG. 6, FIG. 7, FIG. 8, and/or FIG. 10 and/or portions or combinations thereof described herein. In some embodiments, the apparatus 1210 may comprise a processing device 1212, an input device 1214, an output device 1216, a communication device 1218, a memory device 1240, and/or a cooling device 1250. According to some embodiments, any or all of the components 1212, 1214, 1216, 1218, 1240, 1250 of the apparatus 1210 may be similar in configuration and/or functionality to any similarly named and/or numbered components described herein. Fewer or more components 1212, 1214, 1216, 1218, 1240, 1250 and/or various configurations of the components 1212, 1214, 1216, 1218, 1240, 1250 may be included in the apparatus 1210 without deviating from the scope of embodiments described herein.

According to some embodiments, the processor 1212 may be or include any type, quantity, and/or configuration of processor that is or becomes known. The processor 1212 may comprise, for example, an Intel® IXP 2800 network processor or an Intel® XEON™ Processor coupled with an Intel® E7501 chipset. In some embodiments, the processor 1212 may comprise multiple inter-connected processors, microprocessors, and/or micro-engines. According to some embodiments, the processor 1212 (and/or the apparatus 1210 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1210 comprises a server such as a blade server, necessary power may be supplied via a standard AC outlet, power strip, surge protector, and/or Uninterruptible Power Supply (UPS) device.

In some embodiments, the input device 1214 and/or the output device 1216 are communicatively coupled to the processor 1212 (e.g., via wired and/or wireless connections and/or pathways) and they may generally comprise any types or configurations of input and output components and/or devices that are or become known, respectively. The input device 1214 may comprise, for example, a keyboard that allows an operator of the apparatus 1210 to interface with the apparatus 1210 (e.g., by a consumer, such as to purchase insurance policies priced utilizing VED metrics, and/or by an underwriter and/or insurance agent, such as to evaluate risk and/or calculate premiums for an insurance policy, e.g., based on VED as described herein, and/or a claim handler—e.g., to investigate insurance claims utilized VED as described herein). In some embodiments, the input device 1214 may comprise a sensor configured to provide information such as encoded location, engineering parameter and/or risk, and/or VED to the apparatus 1210 and/or the processor 1212. The output device 1216 may, according to some embodiments, comprise a display screen and/or other practicable output component and/or device. The output device 1216 may, for example, provide insurance and/or investment pricing, claims, and/or risk analysis to a potential client (e.g., via a website) and/or to an underwriter, claim handler, or sales agent attempting to structure an insurance (and/or investment) product and/or investigate an insurance claim (e.g., via a computer workstation). According to some embodiments, the input device 1214 and/or the output device 1216 may comprise and/or be embodied in a single device such as a touch-screen monitor.

In some embodiments, the communication device 1218 may comprise any type or configuration of communication device that is or becomes known or practicable. The communication device 1218 may, for example, comprise a Network Interface Card (NIC), a telephonic device, a cellular network device, a router, a hub, a modem, and/or a communications port or cable. In some embodiments, the communication device 1218 may be coupled to provide data to a client device, such as in the case that the apparatus 1210 is utilized to price and/or sell underwriting products (e.g., based at least in part on VED data). The communication device 1218 may, for example, comprise a cellular telephone network transmission device that sends signals indicative of VED metrics to a handheld, mobile, and/or telephone device (e.g., of a claim adjuster). According to some embodiments, the communication device 1218 may also or alternatively be coupled to the processor 1212. In some embodiments, the communication device 1218 may comprise an IR, RF, Bluetooth™, Near-Field Communication (NFC), and/or Wi-Fi® network device coupled to facilitate communications between the processor 1212 and another device (such as a client device and/or a third-party device, not shown in FIG. 12).

The memory device 1240 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1240 may, according to some embodiments, store one or more of VED instructions 1242-1, risk assessment instructions 1242-2, underwriting instructions 1242-3, premium determination instructions 1242-4, client data 1244-1, VED 1244-2, underwriting data 1244-3, and/or claim/loss data 1244-4. In some embodiments, the VED instructions 1242-1, risk assessment instructions 1242-2, underwriting instructions 1242-3, premium determination instructions 1242-4 may be utilized by the processor 1212 to provide output information via the output device 1216 and/or the communication device 1218.

According to some embodiments, the VED instructions 1242-1 may be operable to cause the processor 1212 to process the client data 1244-1, VED 1244-2, underwriting data 1244-3, and/or claim/loss data 1244-4 in accordance with embodiments as described herein. Client data 1244-1, VED 1244-2, underwriting data 1244-3, and/or claim/loss data 1244-4 received via the input device 1214 and/or the communication device 1218 may, for example, be analyzed, sorted, filtered, decoded, decompressed, ranked, scored, plotted, and/or otherwise processed by the processor 1212 in accordance with the VED instructions 1242-1. In some embodiments, client data 1244-1, VED 1244-2, underwriting data 1244-3, and/or claim/loss data 1244-4 may be fed by the processor 1212 through one or more mathematical and/or statistical formulas and/or models in accordance with the VED instructions 1242-1 to define one or more engineering risk and/or VED metrics, indices, and/or models that may then be utilized to inform and/or affect insurance claim handling and/or insurance and/or other underwriting product determinations and/or sales as described herein.

In some embodiments, the risk assessment instructions 1242-2 may be operable to cause the processor 1212 to process the client data 1244-1, VED 1244-2, underwriting data 1244-3, and/or claim/loss data 1244-4 in accordance with embodiments as described herein. Client data 1244-1, VED 1244-2, underwriting data 1244-3, and/or claim/loss data 1244-4 received via the input device 1214 and/or the communication device 1218 may, for example, be analyzed, sorted, filtered, decoded, decompressed, ranked, scored, plotted, and/or otherwise processed by the processor 1212 in accordance with the risk assessment instructions 1242-2. In some embodiments, client data 1244-1, VED 1244-2, underwriting data 1244-3, and/or claim/loss data 1244-4 may be fed by the processor 1212 through one or more mathematical and/or statistical formulas and/or models in accordance with the risk assessment instructions 1242-2 to inform and/or affect risk assessment processes and/or decisions in relation to engineering parameters and/or VED characteristics, as described herein.

According to some embodiments, the underwriting instructions 1242-3 may be operable to cause the processor 1212 to process the client data 1244-1, VED 1244-2, underwriting data 1244-3, and/or claim/loss data 1244-4 in accordance with embodiments as described herein. Client data 1244-1, VED 1244-2, underwriting data 1244-3, and/or claim/loss data 1244-4 received via the input device 1214 and/or the communication device 1218 may, for example, be analyzed, sorted, filtered, decoded, decompressed, ranked, scored, plotted, and/or otherwise processed by the processor 1212 in accordance with the underwriting instructions 1242-3. In some embodiments, client data 1244-1, VED 1244-2, underwriting data 1244-3, and/or claim/loss data 1244-4 may be fed by the processor 1212 through one or more mathematical and/or statistical formulas and/or models in accordance with the underwriting instructions 1242-3 to cause, facilitate, inform, and/or affect underwriting product determinations and/or sales (e.g., based at least in part on VED) as described herein.

In some embodiments, the premium determination instructions 1242-4 may be operable to cause the processor 1212 to process the client data 1244-1, VED 1244-2, underwriting data 1244-3, and/or claim/loss data 1244-4 in accordance with embodiments as described herein. Client data 1244-1, VED 1244-2, underwriting data 1244-3, and/or claim/loss data 1244-4 received via the input device 1214 and/or the communication device 1218 may, for example, be analyzed, sorted, filtered, decoded, decompressed, ranked, scored, plotted, and/or otherwise processed by the processor 1212 in accordance with the premium determination instructions 1242-4. In some embodiments, client data 1244-1, VED 1244-2, underwriting data 1244-3, and/or claim/loss data 1244-4 may be fed by the processor 1212 through one or more mathematical and/or statistical formulas and/or models in accordance with the premium determination instructions 1242-4 to cause, facilitate, inform, and/or affect underwriting product premium determinations and/or sales (e.g., based at least in part on VED) as described herein.

In some embodiments, the apparatus 1210 may function as a computer terminal and/or server of an insurance and/or underwriting company, for example, that is utilized to process insurance claims and/or applications. In some embodiments, the apparatus 1210 may comprise a web server and/or other portal (e.g., an Interactive Voice Response Unit (IVRU)) that provides VED-based claim and/or underwriting product determinations and/or products to clients.

In some embodiments, the apparatus 1210 may comprise the cooling device 1250. According to some embodiments, the cooling device 1250 may be coupled (physically, thermally, and/or electrically) to the processor 1212 and/or to the memory device 1240. The cooling device 1250 may, for example, comprise a fan, heat sink, heat pipe, radiator, cold plate, and/or other cooling component or device or combinations thereof, configured to remove heat from portions or components of the apparatus 1210.

Any or all of the exemplary instructions and data types described herein and other practicable types of data may be stored in any number, type, and/or configuration of memory devices that is or becomes known. The memory device 1240 may, for example, comprise one or more data tables or files, databases, table spaces, registers, and/or other storage structures. In some embodiments, multiple databases and/or storage structures (and/or multiple memory devices 1240) may be utilized to store information associated with the apparatus 1210. According to some embodiments, the memory device 1240 may be incorporated into and/or otherwise coupled to the apparatus 1210 (e.g., as shown) or may simply be accessible to the apparatus 1210 (e.g., externally located and/or situated).

Referring to FIG. 13A, FIG. 13B, FIG. 13C, and FIG. 13D, perspective diagrams of exemplary data storage devices 1340a-d according to some embodiments are shown. The data storage devices 1340a-d may, for example, be utilized to store instructions and/or data such as the VED instructions 1242-1, risk assessment instructions 1242-2, underwriting instructions 1242-3, premium determination instructions 1242-4, client data 1244-1, VED 1244-2, underwriting data 1244-3, and/or claim/loss data 1244-4, each of which is described in reference to FIG. 12 herein. In some embodiments, instructions stored on the data storage devices 1340a-d may, when executed by a processor, cause the implementation of and/or facilitate the methods 500, 600, 700, 800, 1000 of FIG. 5, FIG. 6, FIG. 7, FIG. 8, and/or FIG. 10 and/or portions or combinations thereof described herein.

According to some embodiments, the first data storage device 1340a may comprise a CD, CD-ROM, DVD, Blu-Ray™ Disc, and/or other type of optically-encoded disk and/or other storage medium that is or becomes know or practicable. In some embodiments, the second data storage device 1340b may comprise a USB keyfob, dongle, and/or other type of flash memory data storage device that is or becomes know or practicable. In some embodiments, the third data storage device 1340c may comprise RAM of any type, quantity, and/or configuration that is or becomes practicable and/or desirable. In some embodiments, the third data storage device 1340c may comprise an off-chip cache such as a Level 2 (L2) cache memory device. According to some embodiments, the fourth data storage device 1340d may comprise an on-chip memory device such as a Level 1 (L1) cache memory device.

The data storage devices 1340a-d may generally store program instructions, code, and/or modules that, when executed by a processing device cause a particular machine to function in accordance with one or more embodiments described herein. The data storage devices 1340a-d depicted in FIG. 13A, FIG. 13B, FIG. 13C, and FIG. 13D are representative of a class and/or subset of computer-readable media that are defined herein as “computer-readable memory” (e.g., non-transitory memory devices as opposed to transmission devices or media).

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

In some embodiments, a method comprises (a) receiving, by a processing device and with respect to a first insurance claim of a first insurance policy, a first expert engineering report comprising (i) first liability data for each parameter of a plurality of engineering parameters, and (ii) first value data descriptive of a first value for each parameter of the plurality of engineering parameters, (b) receiving, by the processing device and with respect to a second insurance claim of a second insurance policy, a second expert engineering report comprising (i) second liability data for each parameter of the plurality of engineering parameters, and (ii) second value data descriptive of a second value for each parameter of the plurality of engineering parameters, (c) receiving, by the processing device, a request to analyze a third insurance claim, the request comprising an indication of a third value for at least one of the parameters of the plurality of engineering parameters, wherein the third value for the at least one of the parameters of the plurality of engineering parameters is associated with the third insurance claim, (d) determining, by the processing device and based on (i) the third value for the at least one of the parameters of the plurality of engineering parameters and (ii) at least one of the first value for the at least one of the parameters of the plurality of engineering parameters and the second value for the at least one of the parameters of the plurality of engineering parameters, third liability data for the third insurance claim, and (e) causing, by the processing device and based on the third liability data for the third insurance claim, an outputting of an indication of a determination of the third insurance claim.

According to some embodiments, the first liability data comprises an expert engineering determination regarding whether the first insurance claim should be allowed or denied. In some embodiments, the plurality of engineering parameters comprise one or more of: (i) a distance parameter; (ii) an energy source characteristic parameter; (iii) a soil type parameter; (iv) a hydraulic parameter; and (v) a structural parameter. According to some embodiments, the determining comprises comparing the third value for the at least one of the parameters of the plurality of engineering parameters to at least one of the first value for the at least one of the parameters of the plurality of engineering parameters and the second value for the at least one of the parameters of the plurality of engineering parameters. According to some embodiments, the third liability data comprises data indicative of a likelihood of damage to an object associated with the third insurance claim.

According to some embodiments, the method may further comprise generating, by the processing device and based on the third liability data for the third insurance claim, the determination of the third insurance claim. According to some embodiments, the determination of the third insurance claim comprises an indication of whether the third insurance claim should be allowed or denied. According to some embodiments, the method may further comprise storing, by the processing device, indications of the received first expert engineering report and second expert engineering report. According to some embodiments, the request to analyze the third insurance claim is received via a GUI of a mobile computing device. According to some embodiments, the first expert engineering report is received from a wireless engineering sensor. According to some embodiments, the wireless engineering sensor comprises one or more of a vibration sensor, a strain sensor, a displacement sensor, and a fluid sensor.

In some embodiments, an insurance claim handling system comprises a processing device, and a memory device in communication with the processing device, the memory device storing instructions that when executed by the processing device result in: (a) receiving, with respect to a first insurance claim of a first insurance policy, a first expert engineering report comprising (i) first liability data for each parameter of a plurality of engineering parameters, and (ii) first value data descriptive of a first value for each parameter of the plurality of engineering parameters, (b) receiving, with respect to a second insurance claim of a second insurance policy, a second expert engineering report comprising (i) second liability data for each parameter of the plurality of engineering parameters, and (ii) second value data descriptive of a second value for each parameter of the plurality of engineering parameters, (c) receiving a request to analyze a third insurance claim, the request comprising an indication of a third value for at least one of the parameters of the plurality of engineering parameters, wherein the third value for the at least one of the parameters of the plurality of engineering parameters is associated with the third insurance claim, (d) determining, based on (i) the third value for the at least one of the parameters of the plurality of engineering parameters and (ii) at least one of the first value for the at least one of the parameters of the plurality of engineering parameters and the second value for the at least one of the parameters of the plurality of engineering parameters, third liability data for the third insurance claim, and (e) causing, based on the third liability data for the third insurance claim, an outputting of an indication of a determination of the third insurance claim.

According to some embodiments, a non-transitory computer-readable memory storing instructions that when executed by a processing device result in: (a) receiving, with respect to a first insurance claim of a first insurance policy, a first expert engineering report comprising (i) first liability data for each parameter of a plurality of engineering parameters, and (ii) first value data descriptive of a first value for each parameter of the plurality of engineering parameters, (b) receiving, with respect to a second insurance claim of a second insurance policy, a second expert engineering report comprising (i) second liability data for each parameter of the plurality of engineering parameters, and (ii) second value data descriptive of a second value for each parameter of the plurality of engineering parameters, (c) receiving a request to analyze a third insurance claim, the request comprising an indication of a third value for at least one of the parameters of the plurality of engineering parameters, wherein the third value for the at least one of the parameters of the plurality of engineering parameters is associated with the third insurance claim, (d) determining, based on (i) the third value for the at least one of the parameters of the plurality of engineering parameters and (ii) at least one of the first value for the at least one of the parameters of the plurality of engineering parameters and the second value for the at least one of the parameters of the plurality of engineering parameters, third liability data for the third insurance claim, and (e) causing, based on the third liability data for the third insurance claim, an outputting of an indication of a determination of the third insurance claim.

In some embodiments, a method comprises (a) determining, by a specially-programmed processing device, information descriptive of a first value of an engineering risk parameter of a first object associated with a first insurance policy, (b) determining, by the processing device, stored information descriptive of the engineering risk parameter, the stored information being stored in association with a second insurance policy, (c) determining, by the processing device and based on a comparison of the first value and the stored information, a risk metric for the first object.

According to some embodiments, the method comprises determining, by the processing device and based on the risk metric, an insurance rate for the first insurance policy, and causing, by the processing device, an outputting of an indication of the insurance rate for the first insurance policy. According to some embodiments, the method comprises causing, by the processing device, a sale of the first insurance policy based on the determined insurance rate. According to some embodiments, the determining of the information descriptive of the first value of the engineering risk parameter of the first object associated with the first insurance policy, comprises receiving, via a GUI interface, an indication of the first value. According to some embodiments, the method comprises the engineering risk parameter comprises one or more of: (i) a distance parameter; (ii) an energy source characteristic parameter; (iii) a soil type parameter; (iv) a hydraulic parameter; and (v) a structural parameter. According to some embodiments, the engineering risk parameter comprises the distance parameter and the first value is received via a wireless transmission from a sensor in proximity to the first object. According to some embodiments, the stored information comprises information descriptive of one or more values of the engineering risk parameter that are associated with a previous determination of claim liability with respect to the second insurance policy. According to some embodiments, the method comprises determining, by the processing device and based on the risk metric for the first object, a preventative plan for the first insurance policy, and causing, by the processing device, an outputting of an indication of the preventative plan for the first insurance policy. According to some embodiments, the method comprises receiving, by the processing device and from a wireless sensor device, an indication that the preventative plan has been violated. According to some embodiments, the preventative plan comprises an indication of at least one of: (i) a maximum Peak Particle Velocity (PPV) permitted under the first insurance policy; (ii) a minimum distance between construction activities covered under the first insurance policy and adjacent objects; and (iii) a requirement that photos of adjacent objects be recorded prior to commencement of activities under the first insurance policy. According to some embodiments, the method comprises causing, by the processing device and based on the indication that the preventative plan has been violated, a surcharge to be applied to the first insurance policy.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
aggregating, by an insurance claim handling system, engineering data associated with a plurality of insurance claims;
providing, by the insurance claim handling system and after the aggregating, an interface configured to receive insurance claim data;
receiving, by the insurance claim handling system and via the interface, an indication of data descriptive of a current insurance claim;
determining, by the insurance claim handling system and based on a comparison of the aggregated engineering data and the data descriptive of the current insurance claim, whether the current insurance claim should be (i) denied, (ii) allowed, or (iii) referred for further review; and
outputting, by the insurance claim handling system and via the interface, an indication of the determination.

2. The method of claim 1, wherein the aggregating comprises:
receiving the engineering data; and
storing indications of the engineering data in a database in association with one or more engineering parameter fields.

3. The method of claim 2, wherein the engineering data is received via wireless communication from one or more engineering sensors.

4. The method of claim 3, wherein the one or more engineering sensors comprise one or more of a vibration sensor, a strain sensor, a displacement sensor, and a fluid sensor.

5. The method of claim 1, wherein the receiving, by the insurance claim handling system and via the interface, of the indication of data descriptive of the current insurance claim, comprises:
receiving geolocation data descriptive of a location of an object associated with the current insurance claim.

6. The method of claim 5, wherein the interface comprises a map interface portion and wherein the receiving of the geolocation data descriptive of the location of the object associated with the current insurance claim, comprises:
receiving, via the map interface portion of the interface, a graphical input descriptive of the geolocation data.

7. The method of claim 1, wherein the data descriptive of the current insurance claim comprises data identifying one or more of: (i) a distance of an event from an insured object; (ii) an energy source characteristic parameter descriptive of the event; (iii) a soil type parameter associated with the event; (iv) a hydraulic parameter associated with the event; and (v) a structural parameter associated with the event.

8. An insurance claim handling system, comprising:
a processing device; and
a memory device in communication with the processing device, the memory device storing instructions that when executed by the processing device result in:
aggregating engineering data associated with a plurality of insurance claims;
providing, the aggregating, an interface configured to receive insurance claim data;
receiving, via an interface, an indication of data descriptive of a current insurance claim;
determining, based on a comparison of the aggregated engineering data and the data descriptive of the current insurance claim, whether the current insurance claim should be (i) denied or (ii) allowed; and
outputting, via the interface, an indication of the determination.

9. The system of claim 8, wherein the aggregating comprises:
receiving the engineering data; and
storing indications of the engineering data in a database in association with one or more engineering parameter fields.

10. The system of claim 9, wherein the engineering data is received via wireless communication from one or more engineering sensors.

11. The system of claim 10, wherein the one or more engineering sensors comprise one or more of a vibration sensor, a strain sensor, a displacement sensor, and a fluid sensor.

12. The system of claim 8, wherein the receiving, by the insurance claim handling system and via the interface, of the indication of data descriptive of the current insurance claim, comprises:
receiving geolocation data descriptive of a location of an object associated with the current insurance claim.

13. The system of claim 12, wherein the interface comprises a map interface portion and wherein the receiving of the geolocation data descriptive of the location of the object associated with the current insurance claim, comprises:
receiving, via the map interface portion of the interface, a graphical input descriptive of the geolocation data.

14. The system of claim 8, wherein the data descriptive of the current insurance claim comprises data identifying one or more of: (i) a distance of an event from an insured object; (ii) an energy source characteristic parameter descriptive of the event; (iii) a soil type parameter associated with the event; (iv) a hydraulic parameter associated with the event; and (v) a structural parameter associated with the event.

15. A non-transitory computer-readable memory storing instructions that when executed by a processing device result in:
aggregating engineering data associated with a plurality of insurance claims;
providing, the aggregating, an interface configured to receive insurance claim data;
receiving, via an interface, an indication of data descriptive of a current insurance claim;
determining, based on a comparison of the aggregated engineering data and the data descriptive of the current insurance claim, whether the current insurance claim should be (i) denied or (ii) allowed; and
outputting, via the interface, an indication of the determination.
